(19) United States
(12) Patent Application Publication
(10) Pub. No.: US 2026/0218555 A1
(43) Pub. Date: Jul. 30, 2026

(54) Dump Trailer System

(71) Applicants: Jonathan R. SAUL, Lasalle, MI (US); Rollin SAUL, Lasalle, MI (US)

(72) Inventors: Jonathan R. SAUL, Lasalle, MI (US); Rollin SAUL, Lasalle, MI (US)

(21) Appl. No.: 19/400,165

(22) Filed: Nov. 25, 2025

Related U.S. Application Data
(60) Provisional application No. 63/750,948, filed on Jan. 29, 2025.

(51) Int. Cl. E05D 15/52; B60P 1/26; E05D 3/10; E05D 5/12; E05D 7/00; E05D 11/02

(52) U.S. Cl. CPC E05D 15/52; B60P 1/26; E05D 3/10; E05D 5/121; E05D 7/0027; E05D 11/02; E05D 2005/122; E05Y 2900/516

(57) ABSTRACT

A hinge assembly for a trailer may include a rod, a first plate, a second plate, a third plate, and a retaining ring. The rod defines a rotation axis. The first plate and the second plate are fixed relative to the rotation axis. The third plate is rotatable about the rotation axis. The third plate is fixed to a door of the trailer. The retaining ring circumscribes the rod and is disposed between the third plate and one of the first plate or the second plate. The retaining ring is axially movable along the rod between the first plate and the second plate. The retaining ring is configured to tighten to the third plate to rotatably fix the third plate and the rod.

### CROSS-REFERENCE TO RELATED APPLICATIONS

This application claims the benefit of U.S. Provisional Application No. 63/750,948, filed on Jan. 29, 2025. The entire disclosure of the above application is incorporated herein by reference.

### FIELD

The present disclosure relates to a dump trailer system.

### BACKGROUND

This section provides background information related to the present disclosure and is not necessarily prior art.

A vehicle may be used to tow a trailer, for example a dump trailer. The dump trailer may be attached to a rear end of the vehicle. More specifically, the vehicle may include a trailer hitch disposed at the rear end of the vehicle and the dump trailer may include a coupler disposed at a front end of the trailer. The coupler of the dump trailer can be connected to the trailer hitch of the vehicle to allow the vehicle to tow the dump trailer.

Typical dump trailer systems include a trailer bed, a trailer frame, and a hydraulic system that is configured to move the trailer bed between a first position and a second or dump position. When the trailer bed is in the dump position, material may be removed (i.e. “dumped”) from the dump trailer. The doors of the dump trailer cooperate to open and close to facilitate loading and removal of material.

The present disclosure provides a dump trailer having an improved hinge system, improved hydraulic fluid drain, improved fender attachment, improved lighting features, and improved wire harness and cable routing.

### SUMMARY

This section provides a general summary of the disclosure and is not a comprehensive disclosure of its full scope or all of its features.

In one form, the present disclosure provides a hinge assembly for a trailer. The hinge assembly includes a rod, a first plate, a second plate, a third plate, and a retaining ring. The rod defines a rotation axis. The first plate and the second plate are fixed relative to the rotation axis. The third plate is rotatable about the rotation axis. The third plate is fixed to a door of the trailer. The first plate defines a first aperture extending therethrough. The second plate defines a second aperture extending therethrough. The third plate defines a third aperture extending therethrough. The rod extends through the first aperture, the second aperture, and the third aperture. The retaining ring circumscribes the rod and is disposed between the third plate and one of the first plate or the second plate. The retaining ring is axially movable along the rod between the first plate and the second plate. The retaining ring is configured to tighten to the third plate to rotatably fix the third plate and the rod.

In some configurations of the hinge assembly of the above paragraph, the rod includes a first threaded portion, a second threaded portion, a first non-threaded portion, and a second non-threaded portion.

In some configurations of the hinge assembly of any one or more of the above paragraphs, a diameter of the first threaded portion and the first non-threaded portion is greater than a diameter of the second non-threaded portion.

In some configurations of the hinge assembly of any one or more of the above paragraphs, the first aperture of the first plate circumscribes the rod at the first non-threaded portion.

In some configurations of the hinge assembly of any one or more of the above paragraphs, the second aperture of the second plate circumscribes the rod at the second non-threaded portion.

In some configurations of the hinge assembly of any one or more of the above paragraphs, the rod further includes a first channel, a second channel, and a third channel. The first channel extends through a portion of the first non-threaded portion in a direction perpendicular to the rotation axis. The second channel extends through a portion of the second non-threaded portion in the direction perpendicular to the rotation axis. The third channel extends between the first channel and the second channel in a direction parallel to the rotation axis. The third channel fluidly connects the first channel and the second channel.

In some configurations of the hinge assembly of any one or more of the above paragraphs, fluid disposed in at least one of the first channel, second channel, and third channel is configured to lubricate the hinge assembly.

In some configurations of the hinge assembly of any one or more of the above paragraphs, a diameter of the first aperture of the first plate is greater than a diameter of the second aperture of the second plate.

In some configurations of the hinge assembly of any one or more of the above paragraphs, a height of the door is adjusted in response to moving the rod relative to the third plate between a first position and a second position.

In some configurations of the hinge assembly of any one or more of the above paragraphs, a tilt of the door is adjusted in response to moving the rod relative to the third plate between a first position and a second position.

In another form, the present disclosure provides a hinge assembly. The hinge assembly includes a rod, a first plate, a second plate, a third plate, and a retaining ring. The rod defines a rotation axis. The first plate and the second plate are fixed relative to the rotation axis. The third plate is rotatable about the rotation axis. The third plate is fixed to a movable door. The first plate defines a first aperture extending therethrough. The second plate defines a second aperture extending therethrough. The third plate defines a third aperture extending therethrough. The rod extends through the first aperture, the second aperture, and the third aperture. The retaining ring circumscribes the rod and is disposed between the third plate and one of the first plate or the second plate. The retaining ring is axially movable along the rod between the first plate and the second plate. The retaining ring is configured to tighten to the third plate to rotatably fix the third plate and the rod.

In some configurations of the hinge assembly of the above paragraph, the rod includes a first threaded portion, a second threaded portion, a first non-threaded portion, and a second non-threaded portion.

In some configurations of the hinge assembly of any one or more of the above paragraphs, a diameter of the first threaded portion and the first non-threaded portion is greater than a diameter of the second non-threaded portion.

In some configurations of the hinge assembly of any one or more of the above paragraphs, the first aperture of the first plate circumscribes the rod at the first non-threaded portion.

In some configurations of the hinge assembly of any one or more of the above paragraphs, the second aperture of the second plate circumscribes the rod at the second non-threaded portion.

In some configurations of the hinge assembly of any one or more of the above paragraphs, the rod further includes a first channel, a second channel, and a third channel. The first channel extends through a portion of the first non-threaded portion in a direction perpendicular to the rotation axis. The second channel extends through a portion of the second non-threaded portion in the direction perpendicular to the rotation axis. The third channel extends between the first channel and the second channel in a direction parallel to the rotation axis. The third channel fluidly connects the first channel and the second channel.

In some configurations of the hinge assembly of any one or more of the above paragraphs, fluid disposed in at least one of the first channel, second channel, and third channel is configured to lubricate the hinge assembly.

In some configurations of the hinge assembly of any one or more of the above paragraphs, a diameter of the first aperture of the first plate is greater than a diameter of the second aperture of the second plate.

In some configurations of the hinge assembly of any one or more of the above paragraphs, a height of the door is adjusted in response to moving the rod relative to the third plate between a first position and a second position.

In some configurations of the hinge assembly of any one or more of the above paragraphs, a tilt of the door is adjusted in response to moving the rod relative to the third plate between a first position and a second position.

In another form, the present disclosure provides a door assembly for a trailer. The door assembly includes a door configured to move between a closed position and an open position. The door assembly further includes a hinge assembly. The hinge assembly includes a first rod, a first plate, a second plate, a third plate, and a first retaining ring. The first rod defines a first rotation axis. The first plate and the second plate are fixed relative to the first rotation axis. The third plate is rotatable about the first rotation axis. The third plate is fixed to the door of the trailer. The first plate defines a first aperture extending therethrough. The second plate defines a second aperture extending therethrough. The third plate defines a third aperture extending therethrough. The first rod extends through the first aperture, the second aperture, and the third aperture. The first retaining ring circumscribes the first rod and is disposed between the third plate and one of the first plate or the second plate. The first retaining ring is axially movable along the first rod between the first plate and the second plate. The first retaining ring is configured to tighten to the third plate to rotatably fix the third plate and the first rod.

In some configurations of the door assembly of the above paragraph, the first rod includes a first threaded portion, a second threaded portion, a first non-threaded portion, and a second non-threaded portion.

In some configurations of the door assembly of any one or more of the above paragraphs, a diameter of the first threaded portion and the first non-threaded portion is greater than a diameter of the second non-threaded portion.

In some configurations of the door assembly of any one or more of the above paragraphs, the first aperture of the first plate circumscribes the first rod at the first non-threaded portion.

In some configurations of the door assembly of any one or more of the above paragraphs, the second aperture of the second plate circumscribes the first rod at the second non-threaded portion.

In some configurations of the door assembly of any one or more of the above paragraphs, the first rod further includes a first channel, a second channel, and a third channel. The first channel extends through a portion of the first non-threaded portion in a direction perpendicular to the first rotation axis. The second channel extends through a portion of the second non-threaded portion in the direction perpendicular to the first rotation axis. The third channel extends between the first channel and the second channel in a direction parallel to the first rotation axis. The third channel fluidly connects the first channel and the second channel.

In some configurations of the door assembly of any one or more of the above paragraphs, fluid disposed in at least one of the first channel, second channel, and third channel is configured to lubricate the first hinge assembly.

In some configurations of the door assembly of any one or more of the above paragraphs, the door assembly further includes a second hinge assembly. The second hinge assembly includes a second rod defining a second rotation axis. The second rotation axis is perpendicular to the first rotation axis. The second hinge assembly includes a fourth plate, a fifth plate, and a sixth plate. The fourth plate is fixed relative to the second rotation axis. The fourth plate defines a fourth aperture extending therethrough. The fifth plate is fixed relative to the second rotation axis. The fifth plate defines a fifth aperture extending therethrough. The sixth plate is disposed between the fourth plate and the fifth plate. The sixth plate is rotatable about the second rotation axis. The sixth plate defines a sixth aperture extending therethrough. The sixth plate is fixed to the door. The second hinge assembly includes a second retaining ring circumscribing and engaging the second rod. The second retaining ring is disposed between the sixth plate and one of the fourth plate or the fifth plate. The second rod extends through the fourth aperture, the fifth aperture, and the sixth aperture. The retaining ring is axially movable along the second rod between the fourth plate and the fifth plate. The second retaining ring is configured to tighten to the sixth plate to rotatably fix the sixth plate and the second rod.

In some configurations of the hinge assembly of any one or more of the above paragraphs, a height of the door is adjusted in response to moving the first rod relative to the third plate between a first position and a second position.

In some configurations of the hinge assembly of any one or more of the above paragraphs, a tilt of the door is adjusted in response to moving the first rod relative to the third plate between a first position and a second position.

In another form, the present disclosure provides a trailer frame. The frame includes a first beam extending longitudinally between a first end and an opposite second end. The frame includes a second beam extending longitudinally between a third end and an opposite fourth end. The frame includes a third beam extending laterally between a fifth end and an opposite sixth end and positioned between the first end of the first beam and the third end of the second beam. The frame includes a fourth beam extending laterally between a seventh end and opposite eighth end and positioned between the second end of the first beam and the fourth end of the second beam. The frame further includes a tongue assembly including a first tongue beam and a second tongue beam. The first tongue beam extends between a ninth end and a tenth end. The ninth end is fixed to the second end of the first beam. The first tongue beam extends between a first surface and an opposite second surface. A first dimension is defined at the ninth end between the first surface and the second surface. A second dimension is defined at the tenth end between the first surface and the second surface. The first dimension is greater than the second dimension.

In some configurations of the trailer frame of the above paragraph, the second surface extends at an angle relative to the first surface.

In some configurations of the trailer frame of any one or more of the above paragraphs, the angle is greater than or equal to about 1 degree.

In some configurations of the trailer frame of any one or more of the above paragraphs, the first dimension is greater than or equal to about 8 inches to less than or equal to about 20 inches.

In some configurations of the trailer frame of any one or more of the above paragraphs, the second dimension is less than or equal to about 15 inches.

In some configurations of the trailer frame of any one or more of the above paragraphs, a difference between the first dimension and the second dimension is greater than or equal to about 1 inch to less than or equal to about 10 inches.

In some configurations of the trailer frame of any one or more of the above paragraphs, the tongue assembly further comprises a deck assembly disposed between the first tongue beam the and the second tongue beam.

In some configurations of the trailer frame of any one or more of the above paragraphs, the first tongue beam is configured to drain fluid from the deck assembly.

In some configurations of the trailer frame of any one or more of the above paragraphs, the first tongue beam extends between an outer surface and an inner surface and defines an aperture extending therethrough.

In some configurations of the trailer frame of any one or more of the above paragraphs, an emergency brake cable is configured to be connected to a vehicle and a breakaway switch. The breakaway switch is mounted to the inner surface of the trailer frame.

In some configurations of the trailer frame of any one or more of the above paragraphs, the emergency brake cable is routed through the aperture.

In some configurations of the trailer frame of any one or more of the above paragraphs, a bracket is fixed to the inner surface of the first tongue beam and the breakaway switch is fixed to the bracket.

In some configurations of the trailer frame of any one or more of the above paragraphs, the bracket is L-shaped.

In some configurations of the trailer frame of any one or more of the above paragraphs, the breakaway switch is positioned along an axis parallel to a tow direction of the trailer.

In another form, the present disclosure provides a trailer frame. The frame includes a first beam extending longitudinally between a first end and an opposite second end. The frame includes a second beam extending longitudinally between a third end and an opposite fourth end. The frame includes a third beam extending laterally between a fifth end and an opposite sixth end and positioned between the first end of the first beam and the third end of the second beam. The frame includes a fourth beam extending laterally between a seventh end and opposite eighth end and positioned between the second end of the first beam and the fourth end of the second beam. The frame further includes a tongue assembly including a first tongue beam and a second tongue beam. The first tongue beam extends between a ninth end and a tenth end. The first tongue beam extends between a first surface and a second surface and between an outer surface and an opposite inner surface. An emergency brake cable is connected to a breakaway switch mounted to the inner surface of the first tongue beam.

In some configurations of the trailer frame of the above paragraph, the first tongue beam defines an aperture extending therethrough. The emergency brake cable is routed through the aperture.

In some configurations of the trailer frame of any one or more of the above paragraphs, a bracket is fixed to the inner surface of the first tongue beam and the breakaway switch is fixed to the bracket.

In some configurations of the trailer frame of any one or more of the above paragraphs, the bracket is L-shaped.

In some configurations of the trailer frame of any one or more of the above paragraphs, the breakaway switch is positioned along an axis parallel to a tow direction of the trailer.

In some configurations of the trailer frame of any one or more of the above paragraphs, a first dimension is defined at the ninth end between the first surface and the second surface. A second dimension is defined at the tenth end between the first surface and the second surface. The first dimension is greater than the second dimension.

In some configurations of the trailer frame of any one or more of the above paragraphs, the second surface extends at an angle relative to the first surface.

In some configurations of the trailer frame of any one or more of the above paragraphs, the angle is greater than or equal to about 1 degree.

In some configurations of the trailer frame of any one or more of the above paragraphs, the tongue assembly further comprises a deck assembly disposed between the first tongue beam the and the second tongue beam.

In some configurations of the trailer frame of any one or more of the above paragraphs, the first tongue beam is configured to drain fluid from the deck assembly.

In another form, the present disclosure provides a trailer. The trailer includes a trailer frame, at least one wheel disposed under and connected to the trailer frame, a trailer bed disposed on the trailer frame, and a fender assembly. The trailer bed includes a first wall defining a first plurality of apertures, The fender assembly is mounted to the wall. The fender assembly includes a first fender body fixed to the wall at a first end and extending outward at an angle to an opposite second end. The first fender body extends between a third end and an opposite fourth end. A first plate is fixed to the first fender body. The first plate includes a first plurality of protrusions that are received in the first plurality of apertures.

In some configurations of the trailer of the above paragraph, the first plate is fixed to the first fender body by fasteners selected from the group consisting of: nuts, bolts, rivets, ties, and combinations thereof.

In some configurations of the trailer of any one or more of the above paragraphs, the angle is greater than or equal to about 10 degrees to less than or equal to about 45 degrees.

In some configurations of the trailer of any one or more of the above paragraphs, each of the first plurality of protrusions have a width that is greater than or equal to about 1 inch to less than or equal to about 2 inches.

In some configurations of the trailer of any one or more of the above paragraphs, each of the first plurality of protrusions have a length that is greater than or equal to about 0.1 inch to less than or equal to about 0.5 inch.

In some configurations of the trailer of any one or more of the above paragraphs, each of the first plurality of protrusions are spaced apart at a dimension that is greater than or equal to about 6 inches to less than or equal to about 11 inches.

In some configurations of the trailer of any one or more of the above paragraphs, the first plurality of protrusions and the first plurality of apertures cooperate to position the first fender body relative to the wall and are configured to set the angle of the first fender body relative to the wall.

In some configurations of the trailer of any one or more of the above paragraphs, the first fender body includes a first flange extending from the second end.

In some configurations of the trailer of any one or more of the above paragraphs, the wall includes a second plurality of apertures and a third plurality of apertures. The fender assembly includes a second fender body, a third fender body, a second plate, and a third plate. The second fender body is fixed to the wall at a first end and extends outward to an opposite second end. The second fender body extends between a third end and an opposite fourth end. The third end of the second fender body is coupled to the third end of the first fender body. The third fender body fixed to the wall at a first end and extends outward to an opposite second end. The third fender body extends between a third end and an opposite fourth end. The third end of the third fender body is coupled to the fourth end of the first fender body. The second plate is fixed to the second fender body. The second plate includes a second plurality of protrusions that are received in the second plurality of apertures of the wall. The third plate is fixed to the third fender body. The third plate includes a third plurality of protrusions that are received in the third plurality of apertures of the wall.

In another form, the present disclosure provides a fender assembly for a trailer. The fender assembly is mounted to a wall of the trailer. The fender assembly includes a first fender body fixed to the wall at a first end and extending outward at an angle to an opposite second end. The first fender body extends between a third end and an opposite fourth end. A first plate is fixed to the first fender body. The first plate includes a first plurality of protrusions that are received in the first plurality of apertures.

In some configurations of the fender assembly of the above paragraph, the first plate is fixed to the first fender body by fasteners selected from the group consisting of: nuts, bolts, rivets, ties, and combinations thereof.

In some configurations of the fender assembly of any one or more of the above paragraphs, the angle is greater than or equal to about 10 degrees to less than or equal to about 45 degrees.

In some configurations of the fender assembly of any one or more of the above paragraphs, each of the first plurality of protrusions have a width that is greater than or equal to about 1 inch to less than or equal to about 2 inches.

In some configurations of the fender assembly of any one or more of the above paragraphs, each of the first plurality of protrusions have a length that is greater than or equal to about 0.1 inch to less than or equal to about 0.5 inch.

In some configurations of the fender assembly of any one or more of the above paragraphs, each of the first plurality of protrusions are spaced apart at a dimension that is greater than or equal to about 6 inches to less than or equal to about 11 inches.

In some configurations of the fender assembly of any one or more of the above paragraphs, the first plurality of protrusions and the first plurality of apertures cooperate to position the first fender body relative to the wall and are configured to set the angle of the first fender body relative to the wall.

In some configurations of the fender assembly of any one or more of the above paragraphs, the first fender body includes a first flange extending from the second end.

In some configurations of the fender assembly of any one or more of the above paragraphs, the wall includes a second plurality of apertures and a third plurality of apertures. The fender assembly includes a second fender body, a third fender body, a second plate, and a third plate. The second fender body is fixed to the wall at a first end and extends outward to an opposite second end. The second fender body extends between a third end and an opposite fourth end. The third end of the second fender body is coupled to the third end of the first fender body. The third fender body fixed to the wall at a first end and extends outward to an opposite second end. The third fender body extends between a third end and an opposite fourth end. The third end of the third fender body is coupled to the fourth end of the first fender body. The second plate is fixed to the second fender body. The second plate includes a second plurality of protrusions that are received in the second plurality of apertures of the wall. The third plate is fixed to the third fender body. The third plate includes a third plurality of protrusions that are received in the third plurality of apertures of the wall.

In another form, the present disclosure provides a trailer. The trailer includes a trailer frame and a first wheel disposed under and connected to the trailer frame. The trailer includes a first light housing fixed to the frame. The trailer includes a first light mounted to the first light housing. The first light is configured to project light onto the first wheel.

In some configurations of the trailer of the above paragraph, the first light is configured to project light onto ground adjacent to the first wheel.

In some configurations of the trailer of any one or more the above paragraphs, the first light is mounted to the first light housing at an angle.

In some configurations of the trailer of any one or more the above paragraphs, the first light is a light-emitting diode (LED), incandescent light, halogen light, compact fluorescent flight (CFL), a laser light, and combinations thereof.

In some configurations of the trailer of any one or more the above paragraphs, the first light projects a logo.

In some configurations of the trailer of any one or more the above paragraphs, the trailer includes a second wheel, a second light housing fixed to the trailer frame, and a second light mounted to the second light housing. The second light is configured to project light onto the second wheel.

In some configurations of the trailer of any one or more the above paragraphs, the second light is configured to project light onto ground adjacent to the second wheel.

In some configurations of the trailer of any one or more the above paragraphs, one of the first light and the second light projects light rearwardly and the other of the first light and the second light projects light forwardly.

In one form, the present disclosure provides a trailer. The trailer includes a trailer frame and a first wheel disposed under and connected to the trailer frame. The trailer includes a first light housing fixed to the frame. The trailer includes a first light mounted to the first light housing. The first light is configured to project light onto ground adjacent to the first wheel.

In some configurations of the trailer of the above paragraph, the first light is configured to project light onto the first wheel.

In some configurations of the trailer of any one or more of the above paragraphs, the first light is mounted to the first light housing at an angle.

In some configurations of the trailer of any one or more of the above paragraphs, the first light is a light-emitting diode (LED), incandescent light, halogen light, compact fluorescent flight (CFL), a laser light, and combinations thereof.

In some configurations of the trailer of any one or more of the above paragraphs, the first light projects a logo.

In some configurations of the trailer of any one or more of the above paragraphs, the trailer includes a second wheel, a second light housing fixed to the trailer frame, and a second light mounted to the second light housing. The second light is configured to project light onto ground adjacent to the second wheel.

In some configurations of the trailer of any one or more of the above paragraphs, the second light is configured to project light onto the second wheel.

In some configurations of the trailer of any of the above paragraphs, one of the first light and the second light projects light rearwardly and the other of the first light and the second light projects light forwardly.

In another form, the present disclosure provides a trailer. The trailer includes a trailer frame and a first wheel and a second wheel disposed under and connected to the trailer frame. The trailer includes a first light housing and a second light housing fixed to the frame. The trailer includes a first light mounted at an angle to the first light housing. The trailer includes a second light mounted at an angle to the second light housing. The first light is configured to project light onto (i) the first wheel, (ii) ground adjacent to the first wheel, or both (i) and (ii). The second light is configured to project light onto (i) the second wheel, (ii) ground adjacent to the second wheel, or both (i) and (ii).

In some configurations of the trailer of the above paragraph, one of the first light and the second light projects light rearwardly and the other of the first light and the second light projects light forwardly.

In some configurations of the trailer of any one or more of the above paragraphs, each of the first light and the second light are a light-emitting diode (LED), incandescent light, halogen light, compact fluorescent flight (CFL), a laser light, and combinations thereof.

In some configurations of the trailer of any one or more of the above paragraphs, (i) the first light projects a logo, (ii) the second light projects a logo, or both (i) and (ii).

In another form, the present disclosure provides a trailer including a frame, a wire harness, a first wire harness cover, a second wire harness cover, and a fastener. The frame includes a first longitudinally extending beam, a second longitudinally extending beam, and one or more laterally extending beams disposed below and extending between disposed be the first longitudinally extending beam and the second longitudinally extending beam. The frame includes a first support member and a second support member fixed to the first longitudinally extending beam. The second support member is spaced apart from the first support member. Each of the first support member and the second support member extend between a first surface and a second surface opposite the first surface. The wire harness is mounted to the first longitudinally extending beam via the first support member. The first wire harness cover is removably engaged to the first support member and the second support member. The second wire harness cover is removably engaged to the second support member. Each of the first wire harness cover and the second wire harness cover include a body extending between a first end and a second end. The body includes a first wall and a second wall orthogonal to the first wall. The second end includes a protrusion extending therefrom. The first end of the first wire harness cover contacts the first surface of the first support member. The first end of the second cover contacts the first surface of the second support member. The second end of the first cover contacts the second surface of the second support member. The fastener is configured to secure the first wire harness cover to the second wire harness cover.

In some configurations of the trailer of the above paragraph, a portion of the protrusion of the first wire harness cover is configured to be received in the slot of the second support member.

In some configurations of the trailer of any one or more of the above paragraphs, the fastener is configured to secure the protrusion of the second end of the first wire harness cover to the first end of the second wire harness cover.

In some configurations of the trailer of any one or more of the above paragraphs, the wire harness is a modular wire harness.

In some configurations of the trailer of any one or more of the above paragraphs, a first portion of the wire harness is received in the recess of the first support member.

In some configurations of the trailer of any one or more of the above paragraphs, a second portion of the wire harness is received in the recess of the second support member.

In some configurations of the trailer of any one or more of the above paragraphs, a grommet circumscribes the wire harness and is received in the recess.

In some configurations of the trailer of any one or more of the above paragraphs, the first support member is configured to reduce an amount of movement of the one or more laterally extending beams.

In some configurations of the trailer of any one or more of the above paragraphs, the first support member is aligned with one of the one or more laterally extending beams.

In some configurations of the trailer of any one or more of the above paragraphs, the one or more laterally extending beams include I-beams, C-beams, or combinations thereof.

In another form, the present disclosure provides a trailer frame including a first longitudinally extending beam, a second longitudinally extending beam, and one or more laterally extending beams disposed below and extending between the first longitudinally extending beam and the second longitudinally extending beam. The trailer frame includes a first support member fixed to the first longitudinally extending beam. The first support member is configured to reduce an amount of movement of the one or more laterally extending beams.

In some configurations of the trailer frame of the above paragraph, the first support member is aligned with the one or more laterally extending beams.

In some configurations of the trailer frame of any one or more of the above paragraphs, the one or more laterally extending beams include I-beams, C-beams, or combinations thereof.

In some configurations of the trailer frame of any one or more of the above paragraphs, the first support member extends between a first surface and a second surface opposite the first surface. The first support member defines a recess and a slot extending therethrough.

In some configurations of the trailer frame of any one or more of the above paragraphs, a wire harness is mounted to the first longitudinally extending beam. A portion of the wire harness is received in the recess of the first support member.

In some configurations of the trailer frame of any one or more of the above paragraphs, the wire harness is a modular wire harness.

In some configurations of the trailer frame of any one or more of the above paragraphs, a grommet circumscribes the wire harness and is received in the recess.

In some configurations of the trailer frame of any one or more of the above paragraphs, the trailer frame further includes a second support member fixed to the first longitudinally extending beam. The second support member is spaced apart from the first support member. Each of the first support member and the second support member extend between a first surface and a second surface opposite the first surface. A wire harness is mounted to the first longitudinally extending beam via the first support member. A first wire harness cover is removably engaged to the first support member and the second support member. A second wire harness cover is removably engaged to the second support member. Each of the first wire harness cover and the second wire harness cover include a body extending between a first end and a second end. The body includes a first wall and a second wall orthogonal to the first wall. The second end including a protrusion extending therefrom. The first end of the first wire harness cover contacts the first surface of the first support member and the second end of the first wire harness cover contacts the second surface of the second support member. The first end of the second wire harness cover contacts the first surface of the second support member. A fastener is configured to secure the first wire harness cover to the second wire harness cover.

In some configurations of the trailer frame of any one or more of the above paragraphs, each of the first support member and the second support member define a recess and a slot extending therethrough. A portion of the protrusion of the first wire harness cover is configured to be received in the slot of the second support member.

In some configurations of the trailer frame of any one or more of the above paragraphs, the fastener is configured to secure the protrusion of the second end of the first wire harness cover to the first end of the second wire harness cover.

In another form, the present disclosure provides a dump trailer that may include a trailer frame, a plurality of wheels, a trailer bed, and a latch assembly. The wheels are mounted to the trailer frame (e.g., via a suspension assembly). The trailer bed may be mounted to the trailer frame and defines a cargo space. The trailer bed may be movable relative to the trailer frame about a first rotational axis to a dump position at which a forward end of the trailer bed is raised relative to a rear end of the trailer bed to allow contents of the trailer bed to be dumped from the trailer bed. The trailer bed may include a door attached to a wall of the trailer bed. The door may be rotatable about a second rotational axis relative to the wall between an open position and a closed position. The latch assembly may be configured to selectively retain the door in the open position. The latch assembly includes a first latch member and a second latch member. The first latch member may be attached to the door. The second latch member may be fixedly attached to the wall. The first latch member may be pivotable about a third rotational axis relative to the trailer bed between a first position in which the first latch member is disengaged from the second latch member to allow movement of the door relative to the wall and a second position in which the first latch member is engaged with the second latch position to prevent movement of the door relative to the wall.

In some configurations of the dump trailer of the above paragraph, the first and second rotational axes are perpendicular to each other.

In some configurations of the dump trailer of one or both of the above paragraphs, the third rotational axis is perpendicular to the first and second rotational axes.

In some configurations of the dump trailer of any one or more of the above paragraphs, the first latch member includes an opening that receives a hook formed on the second latch member when the first latch member is in the second position.

In some configurations of the dump trailer of any one or more of the above paragraphs, the hook includes an opening formed therein.

In some configurations of the dump trailer of any one or more of the above paragraphs, the latch assembly includes a pin that selectively engages the opening in the hook while the hook is received in the opening of the first latch member to prevent the first latch member from disengaging the second latch member.

In some configurations of the dump trailer of any one or more of the above paragraphs, the latch assembly includes a stowing tab.

In some configurations of the dump trailer of any one or more of the above paragraphs, the stowing tab is selectively received in the opening in the first latch member when the first latch member is in the first position.

In some configurations of the dump trailer of any one or more of the above paragraphs, the pin is received in an opening in the stowing tab when the first latch member is in the first position to restrict movement of the first latch member.

In some configurations of the dump trailer of any one or more of the above paragraphs, the stowing tab is fixedly attached to the wall of the trailer bed.

In some configurations of the dump trailer of any one or more of the above paragraphs, the first latch member is pivotably attached to a bracket that is fixedly attached to the wall.

In some configurations of the dump trailer of any one or more of the above paragraphs, the second latch member includes a flange portion that is attached to an underside of a ledge of the door.

In some configurations of the dump trailer of any one or more of the above paragraphs, the second latch member includes a slot that receives a lip of the ledge of the door.

In some configurations of the dump trailer of any one or more of the above paragraphs, the stowing tab includes a shoulder that interferes with the first latch member to prevent the first latch member from contacting the wall of the trailer bed.

In another form, the present disclosure provides a trailer that may include a trailer frame, a plurality of wheels, a trailer bed, and a latch assembly. The plurality of wheels are mounted to the trailer frame (e.g., via a suspension). The trailer bed is mounted to the trailer frame and defines a cargo space. The trailer bed may include a door attached to a wall of the trailer bed. The door is movable relative to the wall between an open position and a closed position. The latch assembly may be configured to selectively retain the door in the open position. The latch assembly may include a first latch member and a second latch member. The first latch member may be attached to one of the door and the wall. The second latch member may be fixedly attached to the other of the door and the wall. The first latch member may be pivotable relative to the trailer bed between a first position in which the first latch member is disengaged from the second latch member to allow movement of the door relative to the wall and a second position in which the first latch member is engaged with the second latch position to prevent movement of the door relative to the wall.

In some configurations of the trailer of the above paragraph, the first latch member includes an opening that receives a hook formed on the second latch member when the first latch member is in the second position.

In some configurations of the trailer of one or both of the above paragraphs, the hook includes an opening formed therein.

In some configurations of the trailer of any one or more of the above paragraphs, the latch assembly includes a pin that selectively engages the opening in the hook while the hook is received in the opening of the first latch member to prevent the first latch member from disengaging the second latch member.

In some configurations of the trailer of any one or both of the above paragraphs, the latch assembly includes a stowing tab.

In some configurations of the trailer of any one or both of the above paragraphs, the stowing tab is selectively received in the opening in the first latch member when the first latch member is in the first position.

In some configurations of the trailer of any one or both of the above paragraphs, the pin is received in an opening in the stowing tab when the first latch member is in the first position to restrict movement of the first latch member.

In some configurations of the trailer of any one or both of the above paragraphs, the stowing tab is fixedly attached to the wall of the trailer bed.

In some configurations of the trailer of any one or both of the above paragraphs, the first latch member is pivotably attached to the wall of the trailer bed, and wherein the second latch member is fixedly attached to the door.

In some configurations of the trailer of any one or both of the above paragraphs, the first latch member is pivotably attached to a bracket that is fixedly attached to the wall.

In some configurations of the trailer of any one or both of the above paragraphs, the first latch member is pivotable about a rotational axis that is perpendicular to a rotational axis about which the door rotates relative to the wall.

In some configurations of the trailer of any one or both of the above paragraphs, the second latch member includes a flange portion that is attached to an underside of a ledge of the door.

In some configurations of the trailer of any one or both of the above paragraphs, the second latch member includes a slot that receives a lip of the ledge of the door.

In some configurations of the trailer of any one or both of the above paragraphs, the stowing tab includes a shoulder that interferes with the first latch member to prevent the first latch member from contacting the wall of the trailer bed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIGS. 1A-1D are perspective and side views of a dump trailer in a first position (FIGS. 1A and 1C) and second or dump position (FIGS. 1B and 1D) according to the principles of the present disclosure;

FIGS. 2A-2E are front perspective (2A), rear perspective (2B), side (2C), top (2D) and bottom (2E) views of a trailer bed of the trailer of FIGS. 1A-1D;

FIGS. 3A-3C are views of the trailer bed of FIGS. 1A-1D and 2A-2E including a fender assembly according to the principles of the present disclosure;

FIGS. 4A-4B are perspective (4A) and exploded (4B) views of the fender assembly of FIGS. 3A-3C according to the principles of the present disclosure;

FIGS. 5A-5E are front perspective (5A), rear perspective (5B), side (5C), top (5D) and bottom (5E) views of a trailer frame of the trailer of FIGS. 1-1D according to the principles of the present disclosure;

FIGS. 6A-6B are perspective (6A) and side (6B) of a tongue assembly of the trailer frame of FIGS. 5A-5E;

FIGS. 7A-7C are views of light housings and lights of the trailer frame of FIGS. 5A-5E according to the principles of the present disclosure;

FIG. 8 is a side view of a portion the trailer of FIGS. 1A-1D including the light housings and lights of FIGS. 7A-7C according to the principles of the present disclosure;

FIGS. 9A-9H are perspective (9A) and top (9B) views of the door assembly of FIGS. 1A-1D in a closed position including hinge assemblies (9C-9H) according to the principles of the present disclosure;

FIGS. 10A-10C are perspective views of a hinge of the hinge assembly of FIGS. 9A-9D and 9G-9H;

FIGS. 11A-11D are perspective and side views of the door assembly in a closed position (FIGS. 11A-11B) and a pivot position (FIGS. 11C-11D);

FIGS. 12A-12B are perspective (12A) and top (12B) views of the door assembly in an open position;

FIGS. 13A-13D are views of the door assembly according to the principles of the present disclosure;

FIGS. 14A-14D are views of the door assembly according to the principles of the present disclosure;

FIGS. 15A-15B are perspective views of the tongue assembly of the trailer frame including a brake cable according to the principles of the present disclosure;

FIGS. 16A-16D are views of a wire harness, a support member, and a cover fixed to the trailer frame according to the principles of the present disclosure;

FIG. 17 is a partial perspective view of another trailer with a door in a closed position;

FIG. 18 is another partial perspective view of the trailer of Figure with the door in the closed position;

FIG. 19 is a partial perspective view of the trailer of FIG. 17 with the door in an open position;

FIG. 20 is another partial perspective view of the trailer of Figure with the door in the open position;

FIG. 21 is a perspective view of a latch assembly of the trailer of FIG. 17;

FIG. 22 is an exploded view of the latch assembly;

FIG. 23 is another perspective view of the latch assembly;

FIG. 24 is a partial side view of the latch assembly; and

FIG. 25 is a partial perspective view of a door of the trailer with a latch member of the latch assembly.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

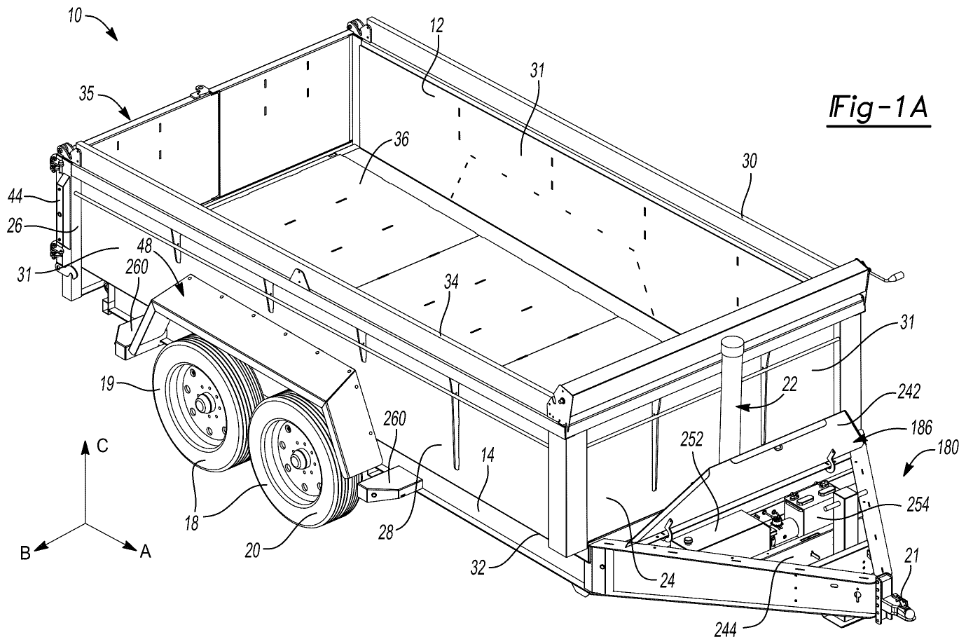

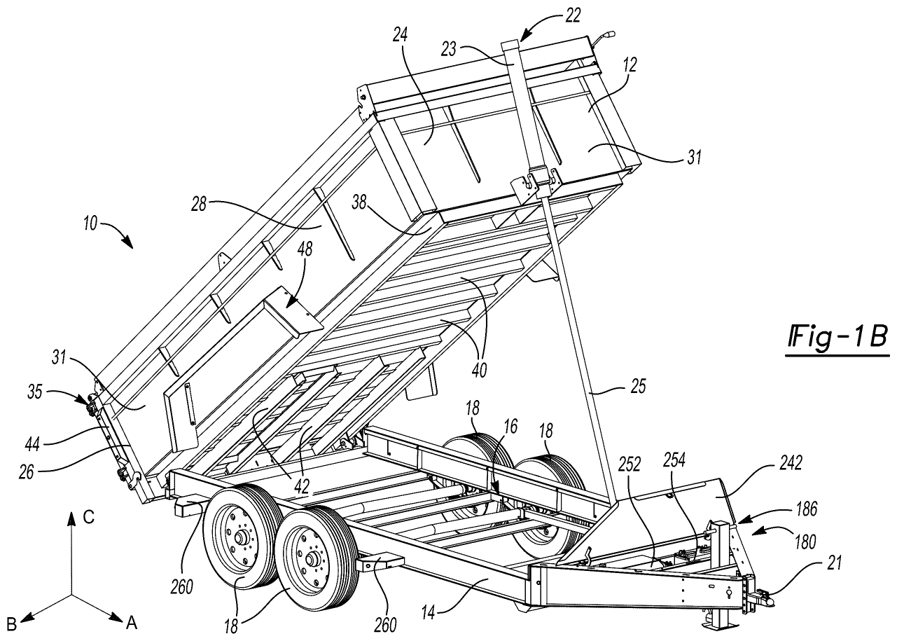

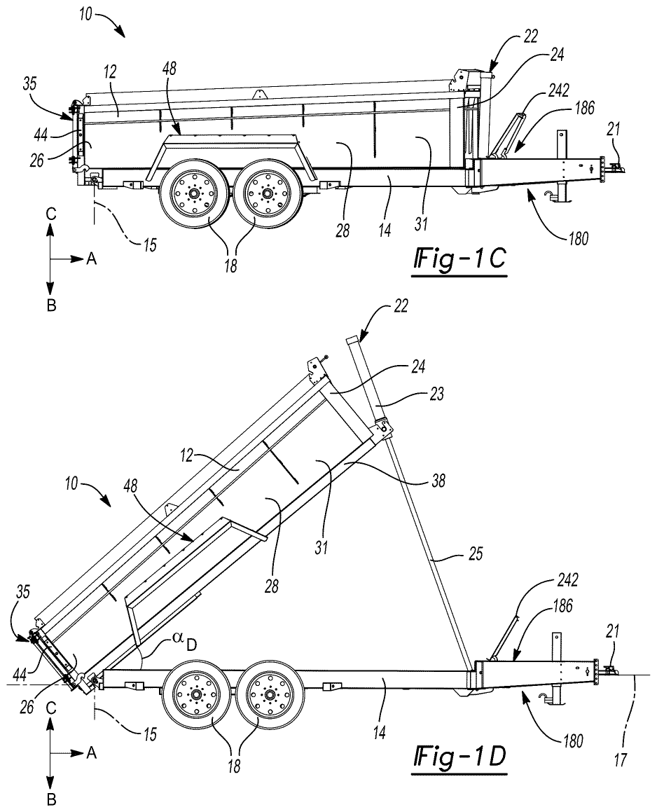

With reference to FIGS. 1A-1D, a trailer 10 is provided that may include a trailer bed 12, a trailer frame 14, a trailer suspension system 16 (FIG. 1B), and one or more sets of wheels 18. In the example embodiment of FIGS. 1A-1D the trailer 10 is a tandem axle tailer including a rear wheel 19 and a front wheel 20. However, it is contemplated that the tailer 10 is a single axle trailer, triaxle trailer, or includes any number of axels and wheels 18.

The trailer 10 may be configured to transport materials (e.g., construction materials, agricultural materials, waste, etc.). The trailer 10 may be a dump trailer. However, the trailer 10 may be another type of trailer, such as an enclosed trailer or a flatbed trailer. The trailer 10 may be attached to a vehicle (not shown), such as via a coupler 21, to allow the vehicle to tow the trailer 10.

The trailer bed 12 is movable between a first or lowered position (FIGS. 1A and 1C) and a second or dump position (FIGS. 1B and 1D) to facilitate the removal of (i.e. dumping) materials from the trailer bed 12. The trailer bed 12 may be movable relative to the trailer frame 14 and pivot about a pivot axis (rotational axis) 15 (FIGS. 1C and 1D) between the first position (FIG. 1C) and the dump position (FIG. 1D). In other words, the trailer bed 12 pivots about the pivot axis 15 between the first position and the dump position, and positions therebetween.

In the dump position, the trailer bed 12 positioned at a dump angle α_{D} (FIG. 1D) relative to a plane 17 of the trailer frame 14. The dump angle α_{D} may be greater than or equal to about 40 degrees to less than or equal to about 60 degrees. More narrowly, the dump and α_{D} may be greater than or equal to about 45 degrees to less than or equal to about 55 degrees. In the example embodiment of FIGS. 1B and 1D, the dump angle α_{D} is about 52 degrees.

The trailer 10 includes a hydraulic cylinder assembly 22 coupled to the trailer bed 12 and the trailer frame 14. The hydraulic cylinder assembly 22 includes a cylinder 23 (FIGS. 1B and 1D) and a movable rod 25 (e.g., a piston rod) slidingly disposed in the cylinder 23. The cylinder 23 may be fixed to the trailer bed 12 via one or more fasteners (e.g., nuts, bolts, rivets, ties), brackets, welds, or links. Similarly, the movable rod 25 may be fixed to the trailer frame 14 via one or more fasteners, brackets, welds, or links. The hydraulic cylinder assembly 22 is configured to move the trailer bed 12 about the pivot axis 15 into the dump position, and vice versa. The position of the cylinder 23 and movable rod 25 relative to the pivot axis 15 of the trailer 10 and size of the hydraulic cylinder assembly 22 enables a larger dump angle α_{D} as compared to conventional dump trailer systems. It is desirable to have a trailer 10 with a larger dump angle α_{D} to facilitate easy egress of materials from the trailer bed 12.

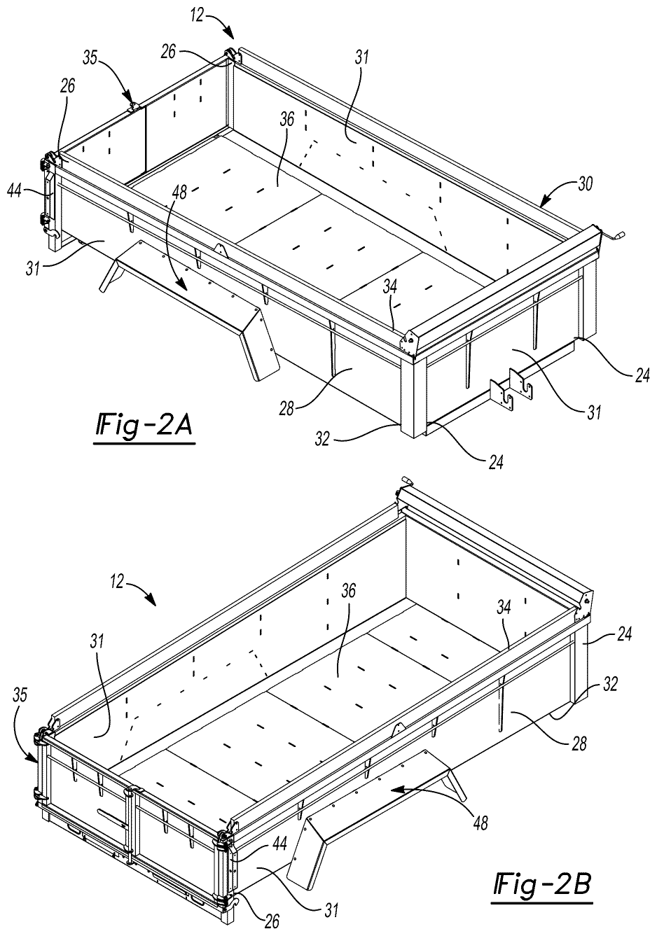

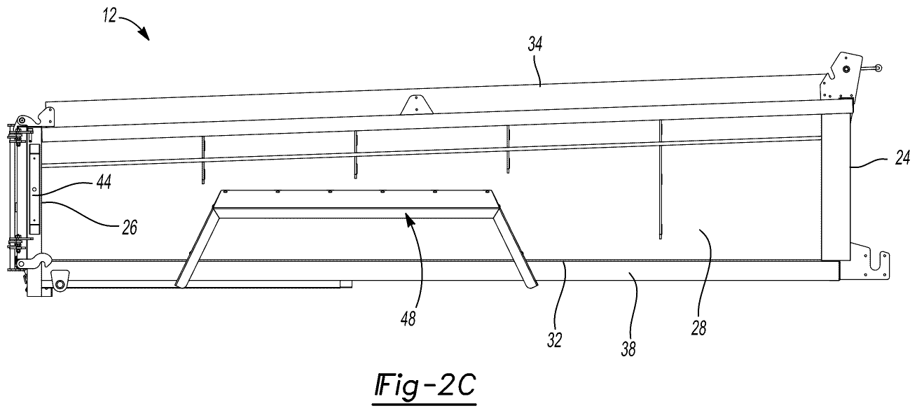

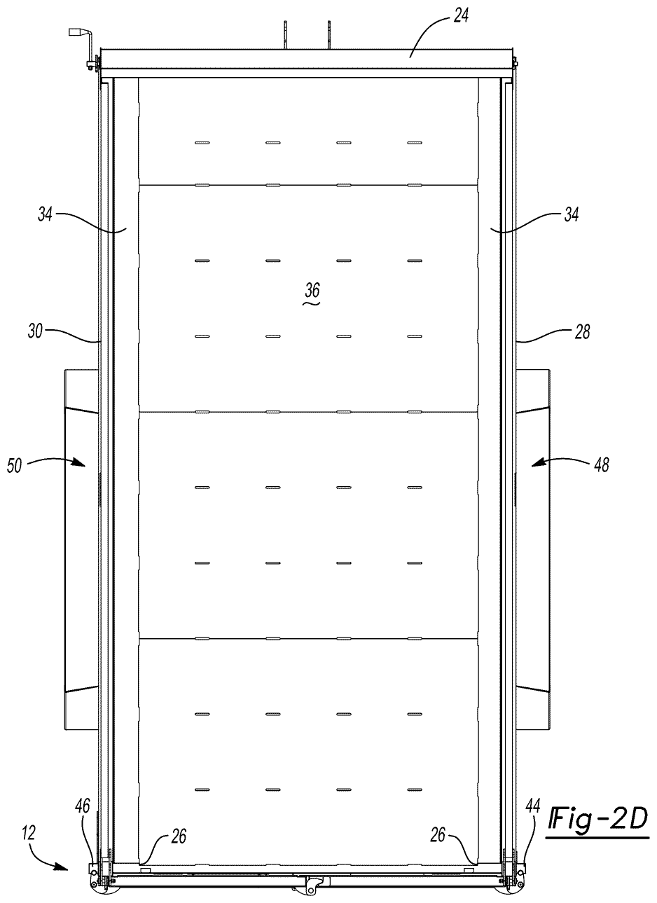

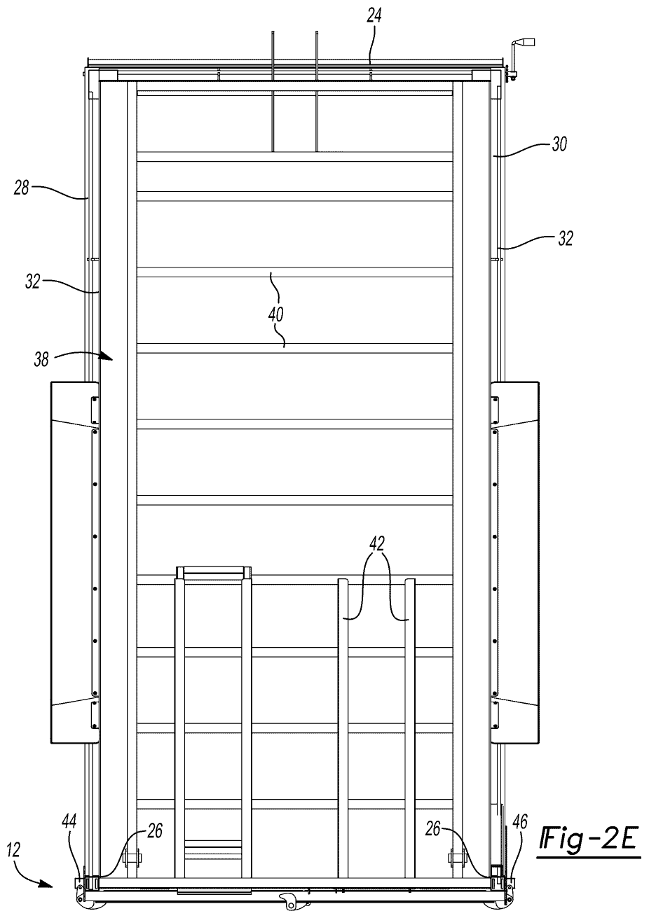

As shown in FIGS. 1A-1D and 2A-2E, the trailer bed 12 may include a front end 24 and a rear end 26 that is opposite to the front end 24. The trailer bed 12 may include a first lateral side 28 and a second lateral side 30 that is opposite to the first lateral side 28. The trailer bed 12 may include one or more walls 31 that extend between a bottom side 32 and a top side 34 that is opposite to the top side 32. The trailer bed includes a door assembly 35 disposed at the rear end 26. The trailer bed 12 may include a trailer platform 36 (e.g., a floor) that is disposed at the bottom side 32 of the walls 31 and extends in a longitudinal or fore-aft direction A (see, e.g., FIGS. 1A-1D) between the front end 24 and the rear end 26 and in a lateral or cross-car direction B between the first lateral side 28 and the second lateral side 30. The trailer platform 36 is disposed on a trailer bed frame 38 (FIGS. 1B and 2E) that supports the trailer platform 36. The trailer bed frame 38 may include one or more laterally extending support beams (e.g., cross rails) 40 extending between the first lateral side 28 and the second lateral side 30. The trailer bed frame 38 may include one or more longitudinally extending support beams (e.g., ramp rails) 42 extending longitudinally from the rear end 26. The walls 31, door assembly 35, and trailer platform 36 cooperate to define an enclosed or partially enclosed space. In some examples, the trailer bed 12 may include additional railings, walls, and or coverings.

The trailer bed 12 may include a first taillight 44 and a second taillight 46 disposed at or near the rear end 26. The first taillight 44 is disposed on the first lateral side 28 and the second taillight 46 is disposed on the second lateral side 30. The first taillight 44 and the second taillight 46 may be mounted or otherwise fastened to the trailer bed 12, such as via fasteners (e.g., nuts, bolts, rivets, ties), brackets, welds, or links. The first taillight 44 and the second taillight 46 may protrude from the respective first lateral side 28 and the second lateral side 30 in the lateral direction B. In other words, a periphery or surface contour of the first taillight 44 and the second taillight 46 is not flush with the walls 31 of the first lateral side 28 and/or the second lateral side 30.

With reference to FIGS. 1A-1D, 2A-2E, 3A-3C, and 4A-4B, the trailer bed 12 includes a first fender assembly 48 disposed on the first lateral side 28 and a second fender assembly 50 disposed on the second lateral side 30. The first fender assembly 48 and the second fender assembly 50 are positioned near the wheels 18. Each of the first fender assembly 48 and the second fender assembly 50 may be configured to cover all or a portion of the rear wheel 19 and the front wheel 20 to protect from debris.

While the description below focuses on the first fender assembly 48, it should be understood that the second fender assembly 50 is configured in the same manner and may be the same as the first fender assembly 48 unless otherwise described. The fender assembly 48 includes a first fender body 52, a second fender body 62, and a third fender body 72. The first fender body 52, second fender body 62, and third fender body 72 may be integrally formed. Alternately, the first fender body 52, the second fender body 62, and the third fender body 72 may be distinct pieces that are joined or otherwise assembled together.

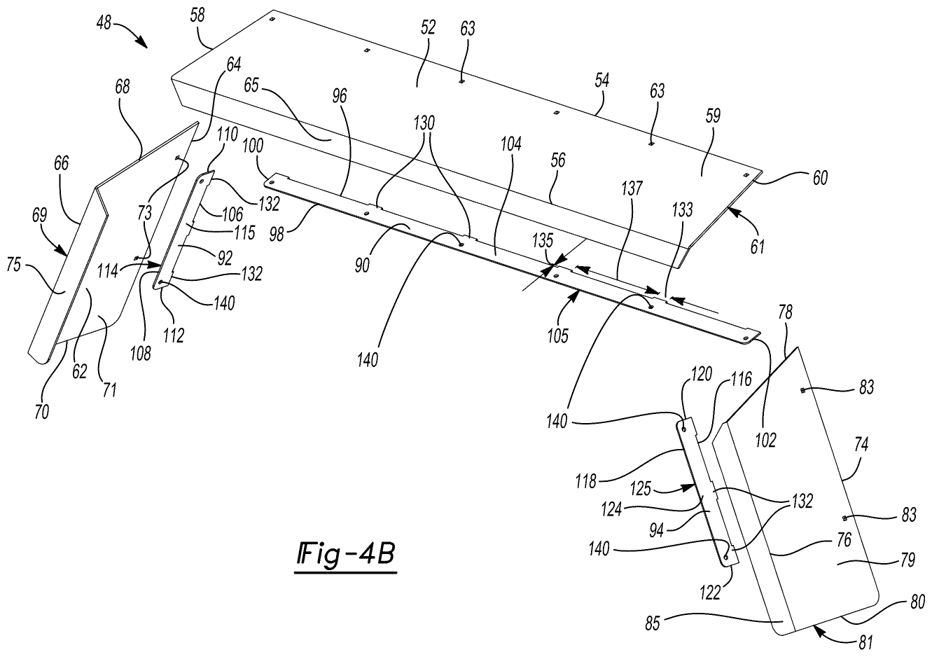

The fender assembly 48 includes the first fender body 52 extending between a first end 54 and an opposite second end 56 and between a third end 58 and an opposite fourth end 60. The first fender body has a first surface 59 (FIG. 4B) and an opposite second surface 61. A plurality of apertures 63 extend through the first fender body 52 and are positioned near the first end 54.

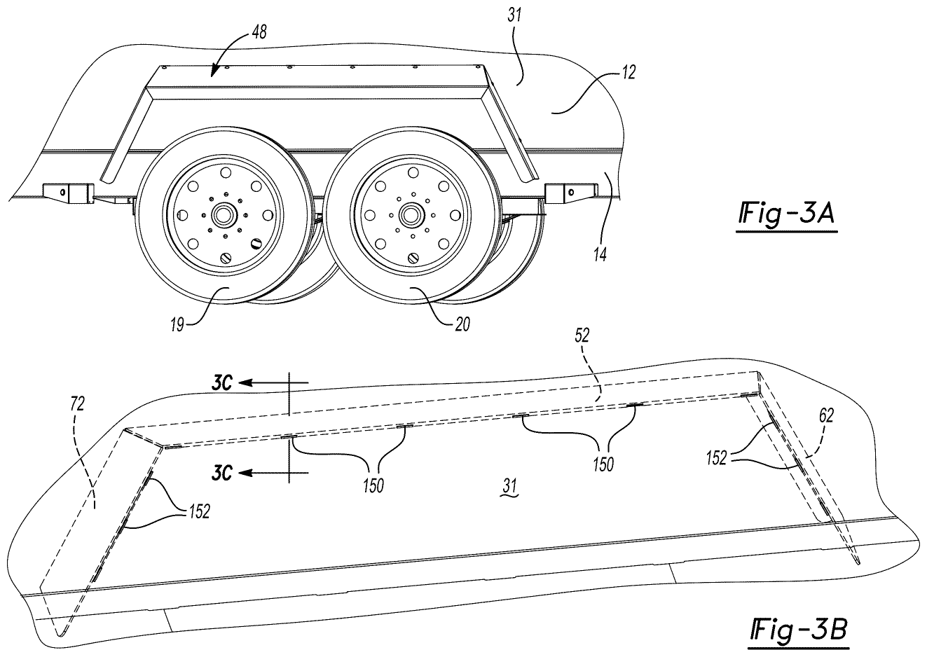

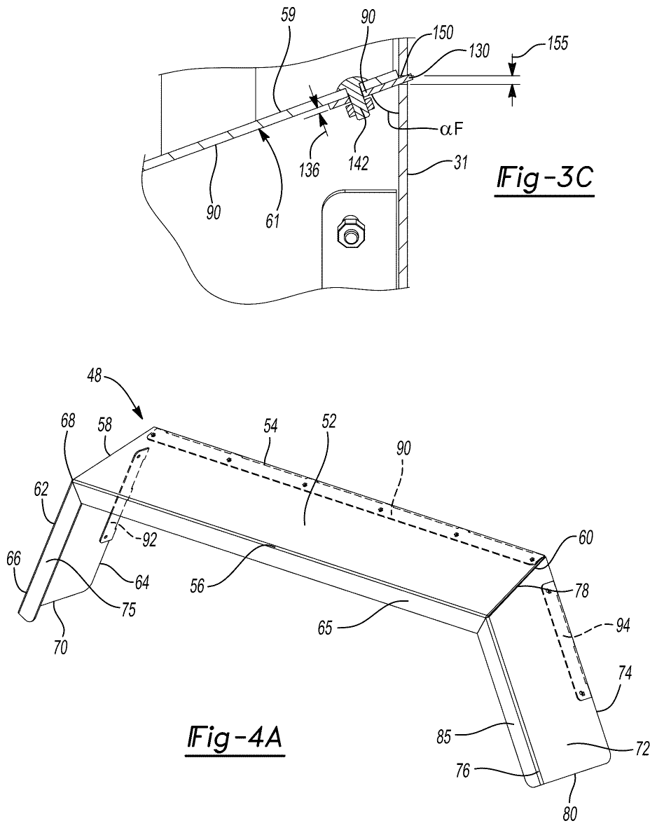

The first end 54 is fixed to the wall 31 of the first lateral side 28 and extends outward and at an angle α_{F} relative to the wall 31 (e.g., a non-perpendicular angle) (FIG. 3C) to the second end 56. The angle α_{F} may be greater than or equal to about 10 degrees to less than or equal to about 75 degrees. More narrowly, the angle α_{F} may be greater than or equal to about 20 degrees to less than or equal to about 50 degrees. The angle α_{F} may be tailored to provide a pre-determined clearance to the wheels 18, designed aesthetic, to direct airflow, and/or prevent debris from contacting the trailer bed 12, the trailer frame 14, the wheels 18, and/or other components of the trailer 10.

A first flange 65 extends downward from the second end 56. In the embodiment of FIG. 4B, the first flange 65 is orthogonal to the first fender body 52. Alternately, the first flange 65 may extend from the second end 56 at an angle that is greater than 90 degrees or less than 90 degrees.

The fender assembly 48 includes the second fender body 62 extending between extending between a first end 64 and an opposite second end 66 and between a third end 68 and an opposite fourth end 70. The second fender body has a first surface 69 and an opposite second surface 71 (FIG. 4B). A plurality of apertures 73 extend through the second fender body 62 and are positioned near the first end 64. The first end 64 is fixed to the wall 31 of the first lateral side 28.

The second fender body 62 is positioned such that the third end 68 of the second fender body 62 is coupled to the third end 58 of the first fender body 52. In the embodiment of FIGS. 3A-3C and 4A-4B, the third end 68 of the second fender body 62 abuts and directly contacts the third end 58 of the first fender body 52. The third ends 58, 68 58 may be joined or fixed via fasteners, welds, brackets, links, and/or adhesives.

A second flange 75 extends inwards from the second end 66 towards the wheels 18. In the embodiment of FIGS. 3A-3C and 4A-4B, the second flange 75 is orthogonal to the body 62. Alternately, the second flange 75 may extend from the second end 66 at an angle that is greater than 90 degrees or less than 90 degrees.

The fender assembly 48 includes the third fender body 72 extending between extending between a first end 74 and an opposite second end 76 and between a third end 78 and an opposite fourth end 80. The third fender body 72 has a first surface 69 (FIG. 4B) and an opposite second surface 81. A plurality of apertures 83 extend through the third fender body 72 and are positioned near the first end 74. The first end 74 is fixed to the wall 31 of the first lateral side 28.

The third fender body 72 is positioned such that the third end 80 of the third fender body 72 is coupled to the fourth end 60 of the first fender body 52. The third end 78 of the third fender body 72 may abut and directly contact the fourth end 60 of the first fender body 52. The third end 78 and the fourth end 60 may be joined or fixed via fasteners, welds, brackets, links, and/or adhesives.

A third flange 85 extends inwards from the second end 76 towards the wheels 18. In the embodiment of FIG. 4B, the third flange 85 is orthogonal to the body 72. Alternately, the third flange 85 may extend from the second end 76 at an angle that is greater than 90 degrees or less than 90 degrees.

The first fender assembly 48 further includes a first plate 90, a second plate 92, and a third plate 94 (collectively, the “plates 90, 92, and 94”). The plates 90, 92, and 94 are configured to structurally support the fender bodies 52, 62, 72 and position and secure the fender bodies 52, 62, 72 to the wall 31 of the trailer bed 12.

The first plate 90 extends between a first end 96 and an opposite second end 98 and between a third end 100 and an opposite fourth end 102. The first plate has a first surface 104 and a second surface 105 opposite the first surface 104. The first plate 90 is fixed to the first fender body 52, such as via fasteners (e.g., nuts, bolts, rivets, ties), brackets, welds, or links. The first surface 104 of the first plate 90 may contact the second surface 61 of the first fender body 52. In the embodiment of 3A-3C and 4A-4B, the first plate 90 has a dimension or length between the third end 100 and the fourth end 102 that is the same dimension or length as the first end 54 of the first fender body 52 between the third end 58 and the fourth end 60. In this way, the third end 100 and the fourth end 102 of the first plate 90 are aligned with the third end 58 and the fourth end 60 of the first fender body 52, respectively. It is contemplated that in other embodiments, the first plate 90 may include a plurality of plates spaced apart along a length of the first fender body 52. Alternately, the first plate 90 may have a length that is less than the length of the first end 54 of the first fender body 52.

The second plate 92 extends between a first end 106 and an opposite second end 108 and between a third end 110 and an opposite fourth end 112. The second plate 92 has a first surface 114 and second surface 115 opposite the first surface 114. The second plate 92 is fixed to the second fender body 62, such as via fasteners (e.g., nuts, bolts, rivets, ties), brackets, welds, or links. The first surface 114 of the second plate 92 may contact the second surface 71 of the second fender body 62. In the embodiment of FIGS. 3A-3C and 4A-4B, the second plate 92 has a dimension or length between the third end 110 and the fourth end 112 that is less than a dimension or length as the first end 64 of the second fender body 62. It is contemplated that in other embodiments, the second plate 92 may include a plurality of plates spaced apart along a length of the second fender body 62 or may have a length that is the same as the length of the first end 64 of the second fender body 62.

The third plate 94 extends between a first end 116 and an opposite second end 118 and between a third end 120 and an opposite fourth end 122. The third plate has a first surface 124 and a second surface 125 opposite the first surface 114. The third plate 94 is fixed to the third fender body 72, such as via fasteners (e.g., nuts, bolts, rivets, ties), brackets, welds, or links. The first surface 124 of the third plate 94 may contact the second surface 81 of the third fender body 72. In the embodiment of FIGS. 3A-3C and 4A-4B, the third plate 94 has a dimension or length between the third end 120 and the fourth end 122 that is less than a dimension or length as the first end 74 of the third fender body 72. It is contemplated that in other embodiments, the third plate 94 may include a plurality of plates spaced apart along a length of the third fender body 72 or may have a length that is the same as the length of the first end 74 of the third fender body 72.

The first plate includes a first plurality of protrusions 130 that extend outward from the first end 96. While not shown in the embodiment of FIGS. 3A-3C and 4A-4B, it is contemplated that the protrusions 130 may extend at an angle relative to the first plate 90. Each of the second and third plates 92 and 94 include a second plurality of protrusions 132 that extend outward from the respective first ends 106 and 116.

As shown in FIGS. 3A-3C and 4A-4B, the protrusions 130 and 132 have a generally rectangular shape, although other shapes and configurations are possible. Each of the protrusions 130, 132 may have a first dimension or width 133 that is greater than or equal to about 1 inch to less than or equal to about 2 inches. Each of the protrusions 130, 132 may have a second dimension or length 135 that is greater than or equal to about 0.1 inch to less than or equal to about 0.5 inch. Each of the protrusions 130, 132 may have a third dimension or width 136 that is greater than or equal to about 0.05 inches to less than or equal to about 1 inch. In one example, the third dimension 136 is about 0.125 inches. Each of the protrusions 130, 132 may be spaced apparat at a third dimension 137 that is greater than or equal to about 6 inches to less than or equal to about 11 inches. It is contemplated that the dimensions of the protrusions 130, 132 may be smaller or larger to achieve the desired strength and design characteristics of the fender assembly 48 and trailer 10.

A plurality of apertures 140 extend through the plates 90, 92, 94 and are aligned with each of the first and/or second plurality of protrusions 130, 132. In the embodiment shown in FIGS. 4A-4B, the first plate 90 includes six (6) evenly spaced protrusions 130 and apertures 140. The second plate 92 and the third plate 94 each include two (2) evenly spaced protrusions 132 and apertures 140. A plurality of fasteners 142 (FIG. 3C) (e.g., nuts, bolts, rivets, ties) may be received in each of the plurality of apertures 140 to secure the plates 90, 92, and 94 to the respective fender bodies 52, 62, and 72. In some embodiments, the plates 90, 92, and 94 may be free of the plurality of apertures 140, such as when the plates 90, 92, and 94 are secured to the fender bodies 52, 62, and 72 via welds or adhesives. Any number of protrusions 130, 132 and apertures 140 may be utilized to achieve the desired strength, fit, and aesthetics of the fender assembly 48.

Referring back to FIGS. 3B-3C, the wall 31 defines a first plurality of apertures 150, a second plurality of apertures 152, and a third plurality of apertures 154 extending therethrough. The first plurality of apertures 150 have a first dimension or height 155 (FIG. 3C). The height 155 may be greater than or equal to about 0.05 inches to less than or equal to about 2 inches. In one example, the height 155 is about 0.2 inches.

The protrusions 130 of the first plate 90 are received in the first plurality of apertures 150. The protrusions 132 of the second plate 92 are received in the second plurality of apertures 152. The protrusions 132 of the third plate 94 are received in the third plurality of apertures 154. The second plurality of apertures 152 and the second plurality of protrusions 132 of the second plate 92 and the third plurality of apertures 154 and the second plurality of protrusions 132 of the third plate 94 cooperate to position the fender assembly 48 relative to the wall 31. In other words, the second plurality of apertures 152 and the third plurality of apertures 154 function as locator holes.

The first plurality of apertures 150 and the first plurality of protrusions 130 of the first plate 90 cooperate to both position the fender assembly 48 and set the pre-determined angle of the fender bodies 52, 62, and 72 relative to the wall 31. The dimensions, configuration, and spacing of the first plurality of protrusions 130 and the first plurality of apertures 150 may be tailored to achieve a desired strength, stiffness, and aesthetic of the fender assembly 48. For example, the height 155 of the first plurality of aperture 150 may correspond to the thickness 136 of the first protrusions 130 of the first plate 90. When the thickness 136 of the first plurality of protrusions 130 is larger, the height 155 of the first plurality of apertures 150 is larger. Conversely, when the thickness 136 of the first plurality of protrusions 130 is smaller, the height 155 of the first plurality of apertures 150 is smaller.

It is contemplated that the fender assembly 48 may be pre-assembled and installed onto the wall 31. Alternately, the fender assembly 48 may be installed in distinct pieces.

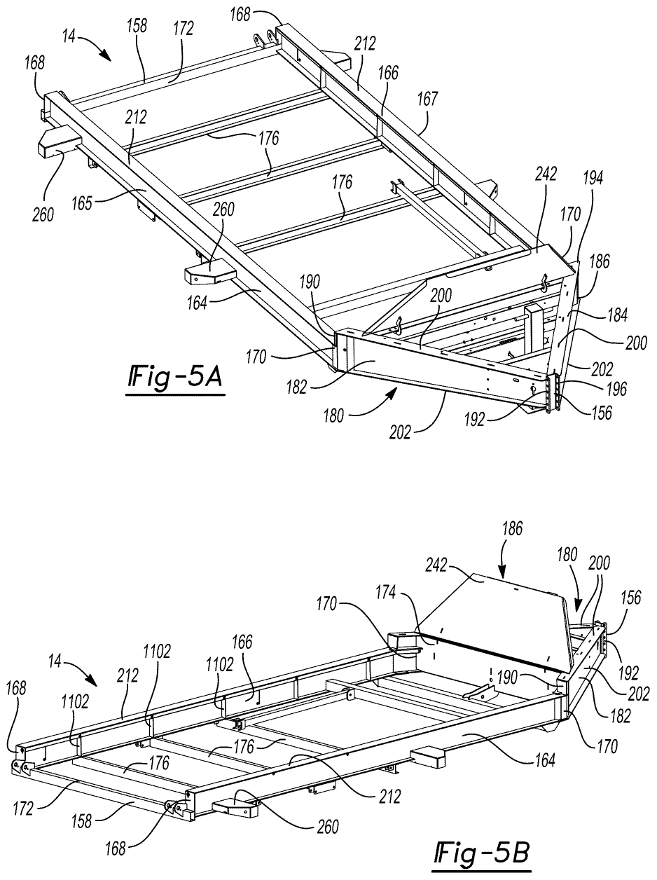

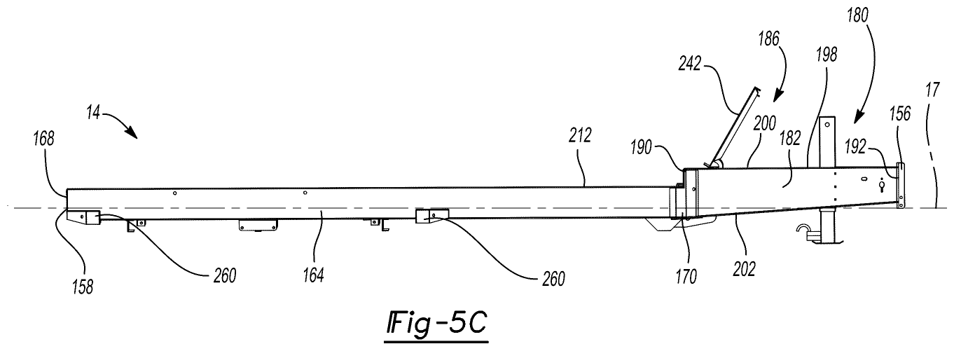

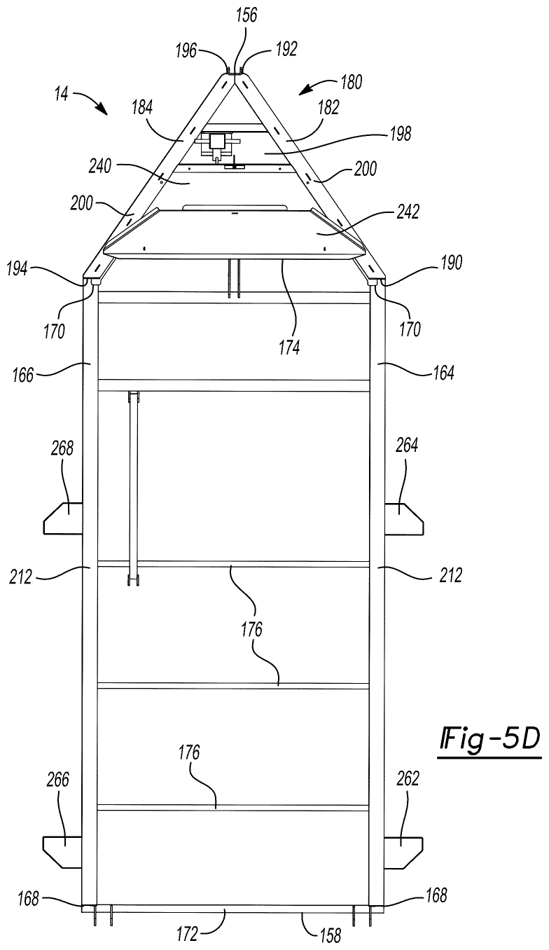

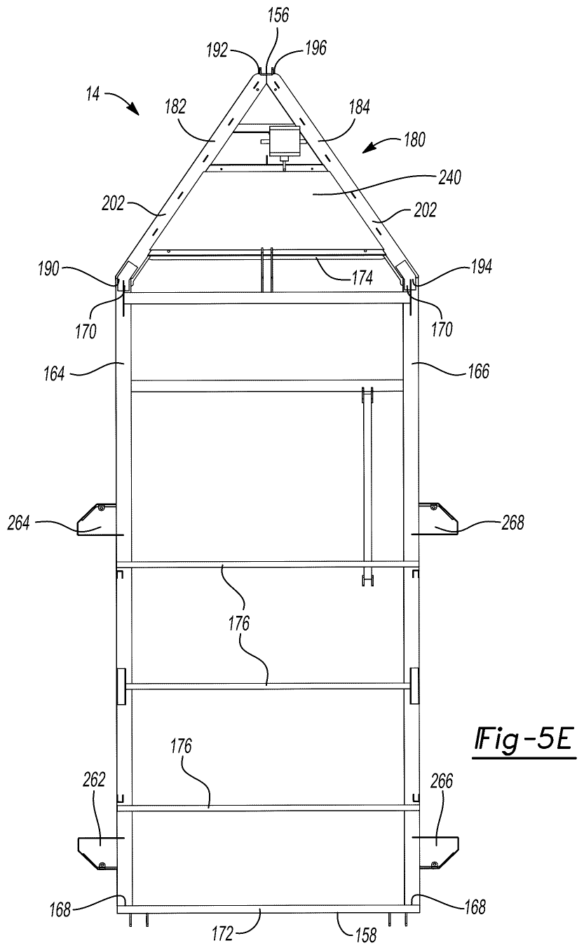

With reference to FIGS. 1A-1D, 5A-5E, and 6A-6B, the trailer frame 14 may include a front end 156 and a rear end 158 that is opposite to the front end 156. The trailer frame 14 may include a first longitudinally extending beam 164 (the “first frame beam 164”) defining a first side and a second longitudinally extending beam 166 (the “second frame beam 166”) defining a second side. Each of the frame beams 164 and 166 extend from a first end 168 near the rear end 162 of the trailer frame 14 to a second end 170. The trailer frame 14 may include a third laterally extending beam 172 (the “third frame beam 172”) disposed at the rear end 162 and fixed to the first ends 168 of the first frame beam 164 and the second frame beam 166. The trailer frame 14 may include a fourth laterally extending beam 174 (the “fourth frame beam 174”) fixed to the second ends 170 of the first frame beam 164 and the second frame beam 166. One or more additional laterally extending beams 176 (e.g., I-beams, C-beams, etc., or combinations thereof) may be disposed between the third frame beam 172 and the fourth frame beam 174 and extend between the first frame beam 164 and the second frame beam 166. The laterally extending beams 176 may include solid beams. Alternately, the laterally extending beams 176 may be hollow structures. In the example embodiment of FIG. 5A-5E, there are three laterally extending beams 176, although a trailer frame 14 including more or fewer beams 176 is contemplated. In some examples, the trailer frame 14 may include additional rails, beams, brackets, and/or other support features.

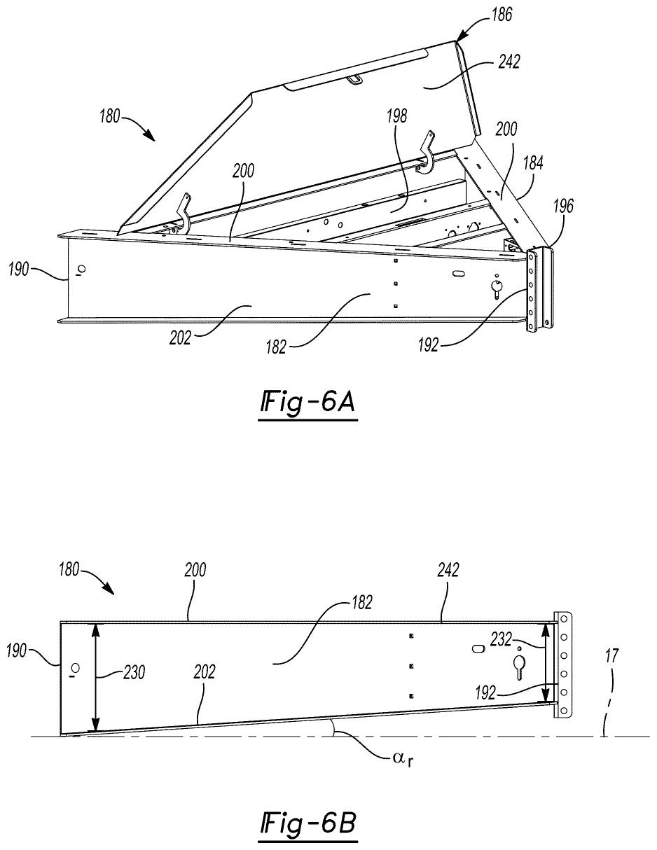

The trailer frame 14 includes a tongue assembly 180 disposed between the fourth frame beam 174 and the front end 156 of the trailer frame 14. The tongue assembly includes a first tongue beam 182, a second tongue beam 184, and a deck assembly 186. A first end 190 of the first tongue beam 182 is fixed to the fourth frame beam 174 and is disposed adjacent to the second end 170 of the first frame beam 164. The first tongue beam 182 extends to a second end 192 adjacent to the front end 156 of the trailer frame 14. A first end 194 of the second tongue beam 184 is fixed to the fourth frame beam 174 and is disposed adjacent to the second end 170 of the second frame beam 166. The second tongue beam 184 extends to a second end 196 adjacent to the front end 156 of the trailer frame 14. The second end 194 of the first tongue beam 182 may be fixed or mounted to the second end 196 of the second tongue beam 184. As shown in the embodiments of FIGS. 5A-5E and 6A-6B, the first tongue beam 182 and the second tongue beam 184 cooperate to define a triangular shaped opening 198, although other shapes and configurations are possible.

As best shown in FIGS. 6A-6B, each of the first tongue beam 182 and the second tongue beam 184 extend between a first or top surface 200 and a second or bottom surface 202 opposite the top surface 200. The first ends 190, 194 have a first dimension or height 230 (FIG. 6B) defined between the top surface 200 and the bottom surface 202. The first dimension 230 may be greater than or equal to about 8 inches to less than or equal to about 16 inches, or more narrowly, greater than or equal to about 10 inches to less than or equal to about 14 inches. The second ends 192, 196 have a second dimension or height 232 defined between the top surface 200 and the bottom surface 202 that is less than the first dimension 230. For example, the second dimension 232 may less than or equal to about 15 inches (e.g., less than or equal to about 12 inches, less than or equal to about 10 inches, less than or equal to about 8 inches, or less than or equal to about 6 inches). A difference between the first dimension 230 and the second dimension 232 may be greater than or equal to about 1 inch to less than or equal to about 10 inches, or more narrowly, greater than or equal to about 2 inches to less than or equal to about 6 inches. In one example, the first dimension 230 is about 12 inches and the second dimension 232 is about 8 inches.

The top surface 200 may be parallel to the plane 17 (FIGS. 1D, 5C and 6B) of the trailer frame 14. For example, the top surface 200 of each of the first tongue beam 192 and the second tongue beam 194 may be parallel to with a first or top surface 212 (FIG. 5A-5D) of the first frame beam 164 and the second frame beam 166 and/or a first or top surface (not shown) of the fourth frame beam 170. The bottom surface 202 may extend at an angle α_{T} relative to the plane 17 of the trailer frame 14 (i.e., the bottom surface extends at the angle α_{T} relative to the top surface 200). The angle α_{T} may be greater than or equal to about 1 degrees to less than or equal to about 45 degrees (e.g., greater than or equal to about 1 degrees to less than or equal to about 5 degrees, greater than or equal to about 5 degrees to less than or equal to about 10 degrees, greater than or equal to about 10 degrees to less than or equal to about 15 degrees, greater than or equal to about 15 degrees to less than or equal to about 20 degrees, greater than or equal to about 20 degrees to less than or equal to about 25 degrees, greater than or equal to about 25 degrees to less than or equal to about 30 degrees, greater than or equal to about 30 degrees to less than or equal to about 35 degrees, greater than or equal to about 35 degrees to less than or equal to about 40 degrees, or greater than or equal to about 40 degrees to less than or equal to about 45 degrees).

With renewed reference to FIGS. 1A-1D and 5A-5E, the deck assembly 186 is disposed in the opening 198 of the tongue assembly 180 and fixed or mounted to at least a portion of the first tongue beam 192 and the second tongue beam 194. The deck assembly 186 may include a floor 240 (FIGS. 5D and 5E) and a lid 242. The floor 240 and the lid 242 may cooperate to define a cavity 244 therebetween (FIG. 1A). Components of the hydraulic cylinder assembly 22 including a hydraulic pump 252 (FIG. 1A), hydraulic fluid (not shown) (e.g., disposed in a hydraulic fluid reservoir or tray) and a battery 254 may be disposed in the cavity 244. Other components such as wire harness(es), cable(s), etc., may also be disposed in the cavity 244 of the deck assembly 186. The lid 242 may be movable between a closed position (FIG. 6B) during operation of the dump trailer 10 and an open position (FIG. 6A) to facilitate easy access to the components housed therein.

During the operation of the hydraulic cylinder assembly 22, hydraulic fluid stored within the deck assembly 186 is pumped through the hydraulic cylinder 23 to move the movable rod 25 between the first position and the dump position. The hydraulic pump 252 may generate the pressure required to push the fluid through the hydraulic cylinder 23. When the movable rod 25 extends to the dump position, fluid may flow out of the cylinder 23 and into the cavity 244. In conventional systems, during operation of the hydraulic cylinder assembly 22, hydraulic fluid may pool around the hydraulic pump 252 which reduces efficiency and leads to reduced or lower pressure or performance of the hydraulic cylinder assembly 22. Moreover, excess or pooled hydraulic fluid risks contamination of other system parts.

The configuration of the first tongue beam 180 and the second tongue beam 184 facilitates draining of excess fluid (e.g., hydraulic fluid, water, oil, grease, etc.) from the trailer 10 to reduce or eliminate an amount of fluid pooled in the deck assembly 186. Specifically, the difference in the first dimension 230 and the second dimension 232 and angle α_{T} may be tailored to tilt the tongue assembly 180 relative the trailer frame 14. This tilt enables fluid to route and drain out of the deck assembly 186, such as via apertures or drain holes (not shown) in the tongue beams 190, 192 and/or deck assembly 186.

With reference to FIGS. 5A-5E, 7A-7C, and 8, the trailer frame 14 may include one of more light housings 260. As best shown in FIGS. 5D-5E, the one or more light housings 260 may include a first light housing 262 and a second light housing 264 fixed to the first frame beam 164 and a third light housing 266 and a fourth light housing 268 fixed to the second frame beam 166. The first light housing 262 may be disposed between the first end 168 of the first trailer beam 164 and the set of wheels 18 and positioned adjacent to the rear wheel 19. The second light housing 264 may be disposed between the set of wheels 18 and the second end 170 of the first trailer beam 164 and positioned adjacent to the front wheel 20. Similarly, the third light housing 266 may be disposed between the first end 168 of the second trailer beam 166 and the set of wheels 18 and positioned adjacent to the rear wheel 19. The fourth light housing 268 may be disposed between the set of wheels 18 and the second end 170 of the second beam 166 and positioned adjacent to the front wheel 20.

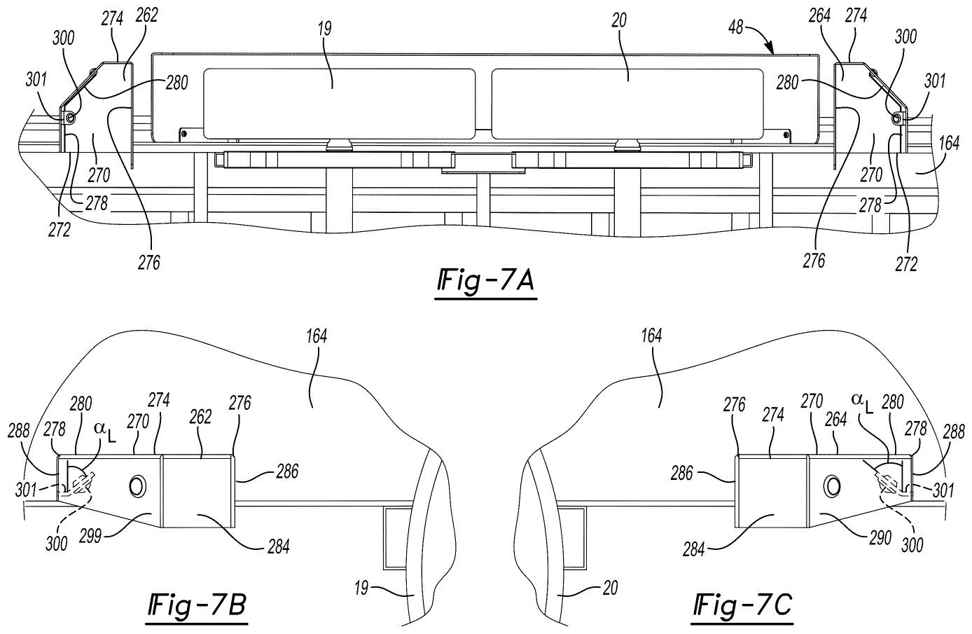

As best shown in FIGS. 7A-7C, each of the light housings includes a body 270 extending between a first side 272 and a second side 274 opposite the first side 272. The body 270 extends between a third side 276 and a fourth side 278 opposite the third side 276. A dimension of the second side 274 is less than a dimension of the first side 272 and a dimension of the fourth side 278 is less than a dimension of the third side 276. The body includes a fifth side 280 extending at an angle between the second side 274 and the fourth side 278. A second wall 284 may extend perpendicularly from the second side 274, a third wall 286 may extend perpendicularly from the third side 276, a fourth wall 288 may extend perpendicularly from the fourth side 278, and a fifth wall 290 may extend perpendicularly from the fifth side 280. The body 270, and walls 282, 284, 286, 288, and 290 may cooperate to define a cavity therebetween. The body 270 and the walls 284, 286, 288, and 290 may be integrally formed. In some examples, one or more of the walls 284, 286, 288, and/or 290 may be joined to the body, such as via fasteners, welds, brackets, links, and/or adhesives.

The first side 272 may be fixed or mounted to the trailer frames. For example, the first side 272 of the first light housing 262 and the second light housing 264 are fixed to the first trailer beam 164 and the first wall 282 of the third light housing 266 and the fourth light housing 268 is fixed to the second trailer beam 166. Each of the light housings 262, 264, 266, and 268 are oriented such that the third wall 286 is positioned closest to the adjacent wheel 18. For example, the third wall 286 of the first light housing 262 is positioned adjacent to the rear wheel 19 and the fourth wall 288 is positioned between the third wall 286 and the rear end 168 of the first trailer beam 164. The third wall 286 of the second light housing 264 is positioned adjacent to the front wheel 20 and the fourth wall 288 is positioned between the third wall 286 and the front end 170 of the first trailer beam 164. Similarly, the third wall 286 of the third light housing 266 is positioned adjacent to the rear wheel 19 and the fourth wall 288 is positioned between the third wall 286 and the rear end 168 of the second trailer beam 166. The third wall 286 of the fourth light housing 268 is positioned adjacent to the front wheel 20 and the fourth wall 288 is positioned between the third wall 286 and the front end 170 of the second trailer beam 166.

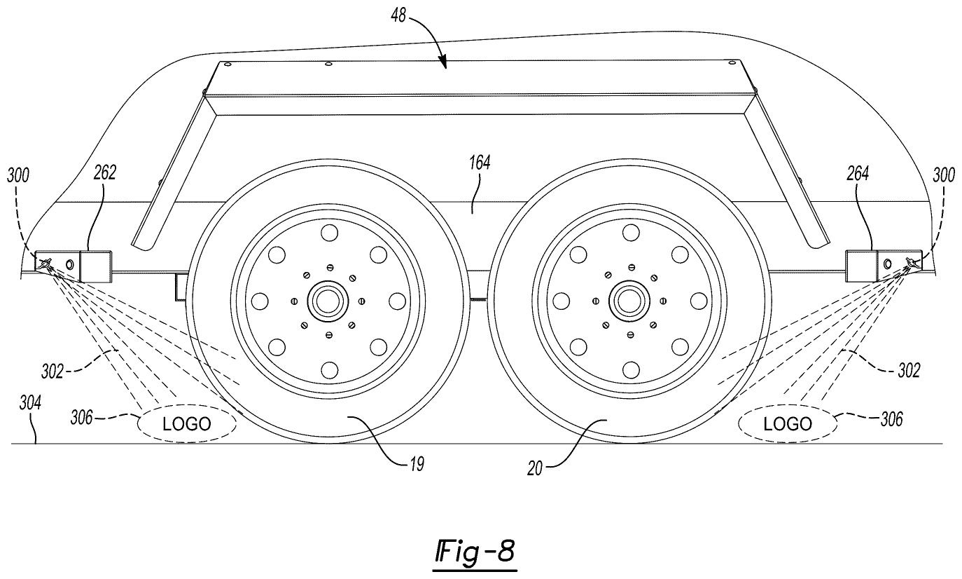

A light 300 is disposed in each of the light housings 262, 264, 266, and 268. The light 300 may be a light-emitting diode (LED), incandescent light, halogen light, compact fluorescent flight (CFL), a laser light, and/or combinations thereof. The light 300 is positioned adjacent to the fourth wall 288. The light 300 may be fixed or mounted to the light housings 262, 264, 266, and 268 (e.g., fixed to one or both of the body 270 and/or fourth wall 288) via one or more fasteners (e.g., nuts, bolts, rivets, ties), brackets, welds, or links. In the example embodiment of FIGS. 7A-7C, the light 300 is fixed to the fourth wall 288 via a bracket 301. The light 300 is positioned at an angle α_{L} (FIGS. 7A-7B) relative to the fourth wall 288. In the embodiment shown in FIG. 8, at least a portion of emitted light 302 (FIG. 8) projects onto the adjacent wheel 18 and a portion of the light 302 projects onto the ground 304 (FIG. 8). However, it is contemplated that the light 302 projects onto only one of the adjacent wheel 18 or the ground 304. In one example, the light 302 projects forwardly towards an adjacent wheel 18 and/or ground 304. In another example, the light 302 projects rearwardly towards an adjacent wheel 18 and/or ground 304. As can be appreciated by those skilled in the art of projecting lights, the light 300 may be designed to project a logo 306, shape, and/or pattern onto the ground 304 and/or one of the wheels 18. The angle α_{L} of the light 300, position of the light 300 relative to one or more wheels 18, and the type or intensity of the light 300 may be tailored to achieve the desired lighting characteristics and projection area.

Projecting light 302 onto one or more of the wheels 18 and/or the ground 304 assists driver navigation in low-light conditions. For example, projecting light 302 onto the one or more of the wheels 18 and/or ground 304 may aid in parking, prevent collisions with obstacles, and improve the driver's sense of where one or more of the wheels 18 are in relation to its surroundings. Thus, projecting light 302 onto one or more of the wheels 18 and/or the ground 304 may prevent contact with curbs or other objects that may damage the wheels 18 and/or tires. Additionally, the projected light 302 may assist the driver in repairing or replacing the wheels 18 and/or tires of the trailer 10.

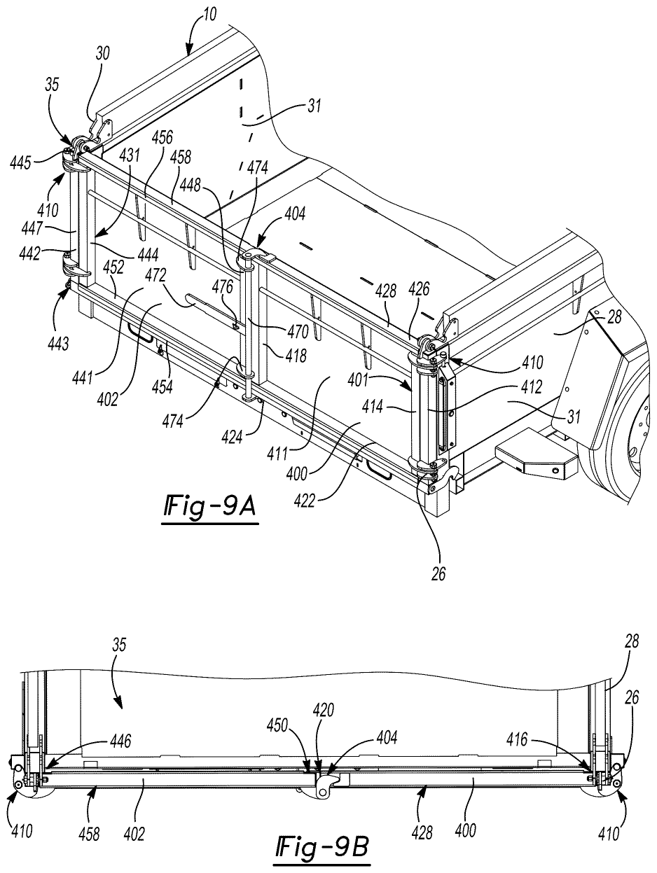

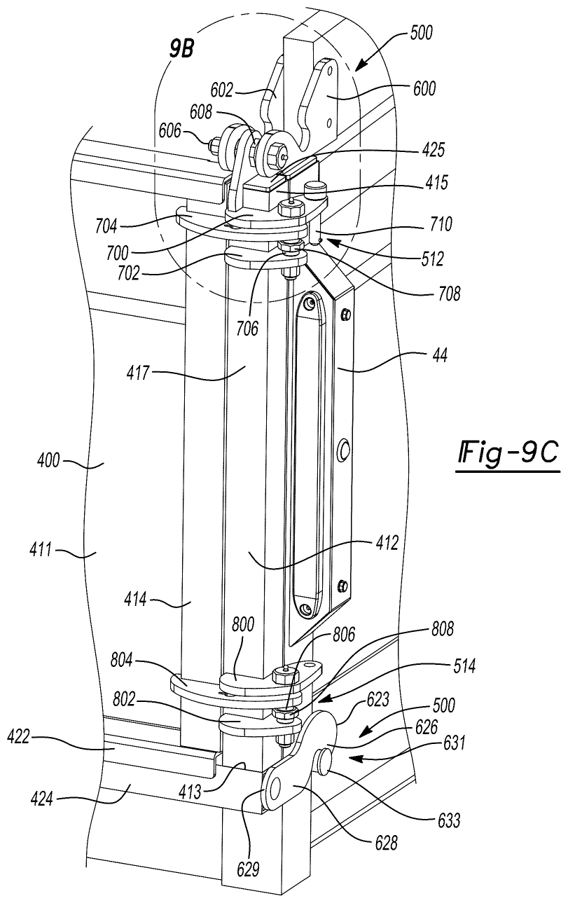

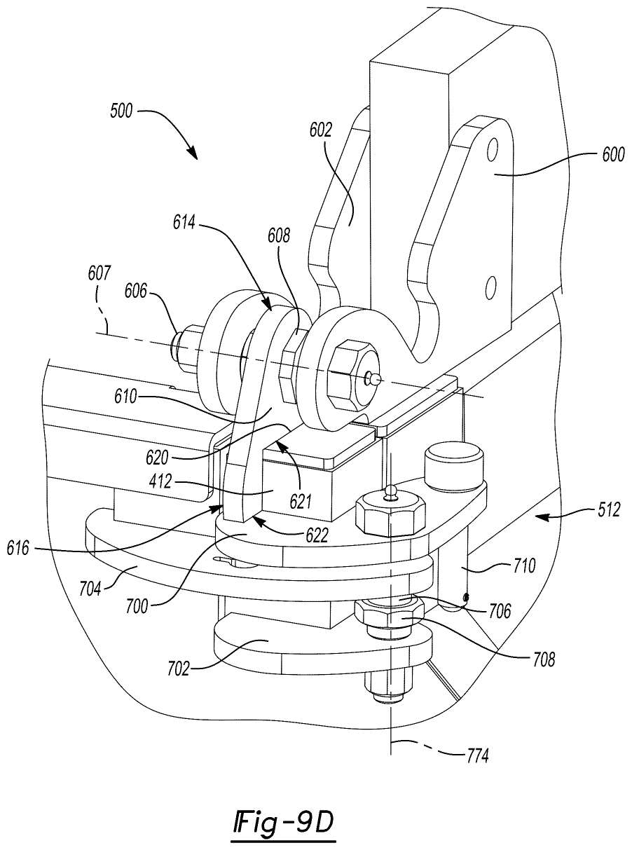

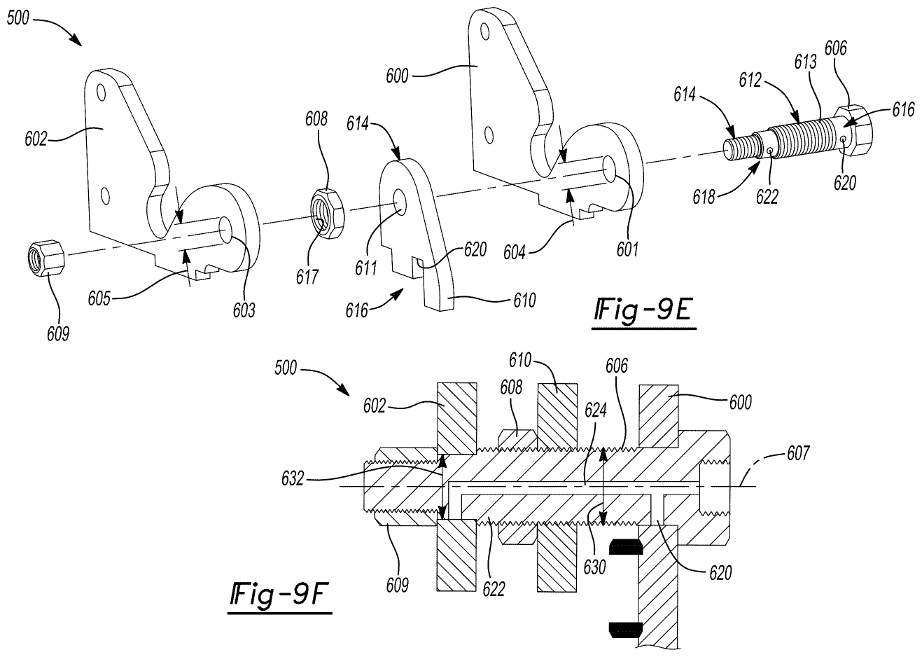

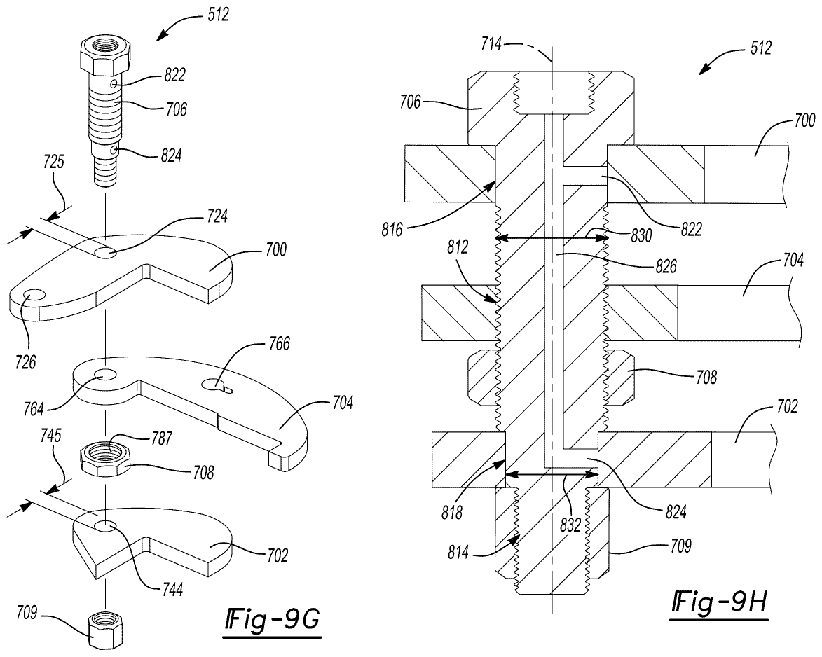

With reference to FIGS. 9A-9D, the trailer 10 includes the door assembly 35 mounted to the trailer bed 12. The door assembly 35 includes a first door 400, a second door 402 (collectively, the “doors 400, 402”), a latch mechanism 404, and one or more hinge assemblies 410. The first door 400 is mounted to the wall 31 of the first lateral side 28 and the second door 402 is mounted to the wall of the second lateral side 30 via the hinge assembly 410.

The first door 400 includes a frame 401 and a body 411. The frame 401 includes a first member 412 and a second member 414 disposed on a first side 416 (FIG. 9B) of the body 411. The first member 412 extends between a first or lower end 413 (FIG. 9C) and a second or upper end 415. The first member 412 may have a generally rectangular shape. In some embodiments, the first member 412 is a hollow member formed of four intersecting walls 417. The first member may include an end cap or cover 425 disposed at the second end 415.

The frame 401 includes a third member 418 disposed on a second side 420 (FIG. 9B) of the body 411 that is opposite the first side 416. The frame 401 may include a fourth member 422 disposed on a third side 424 (FIG. 9A) of the body 411 that extends between the second member 414 and the third member 418. The frame 401 may include a fifth member 426 disposed on a fourth side 428 of the body 411 opposite the third side 426 that extends between the second member 414 and the third member 418. Each of the members 414, 418, 422 and 426 are fixed to the body 411, such as via welding. The first member 412 is positioned adjacent to the first side 416 and movably connected to the second member 414. The first member 412 is positioned adjacent and movably connected to the rear end 26 of the first lateral side 28 of the trailer bed 12. In the embodiment shown in FIGS. 9A-9D, the members 412, 414, 418, 422, and 426 are distinct structural pieces that are coupled or joined together; however, it is possible for all or a portion of the members 412, 414, 418, 422, and 426 to be integrally formed.

The second door 402 includes a frame 431 and a body 441. The frame 431 includes a first member 442 and a second member 444 disposed on a first side 446 (FIG. 9B) of the body 441. The first member 442 extends between a first or lower end 443 (FIG. 9A) and a second or upper end 445. The first member 442 may have a generally rectangular shape. In some embodiments, the first member 442 is a hollow member formed of four intersecting walls 447. The first member may include an end cap or cover (not shown) disposed at the second end 445.

The frame 431 includes a third member 448 (FIG. 9A) disposed on a second side 450 (FIG. 9B) of the body 441 that is opposite the first side 446. The frame 431 includes a fourth member 452 disposed on a third side 454 of the body 441 that extends between the second member 444 and the third member 448. The frame 431 includes a fifth member 456 disposed on a fourth side 458 of the body 441 opposite the third side 456 that extends between the second member 444 and the third member 448. Each of the members 444, 448, 452 and 456 are fixed to the body 441, such as via welding. The first member 442 is positioned adjacent to the first side 446 and movably connected to the second member 424. The first member 442 is positioned adjacent and movably connected to the rear end 26 of the second lateral side 30 of the trailer bed 12.

The first side 416 of the first door 400 is disposed at or near the rear end 26 of the first lateral side 28 of the trailer bed 12. The first side 446 of the second door 402 is disposed at or near the rear end 26 of the second lateral side 30. In a closed position, the second side 420 of the first door 400 abuts the second side 450 of the second door 402. The third sides 424, 454 of the doors 400, 402 are disposed at the bottom side 32 of the trailer bed 12 and are disposed above and spaced apart from the third frame beam 172 of the trailer frame 14. The fourth sides 428, 458 are disposed at the top side 34 of the trailer bed 12. In some examples, the doors 400, 402 may include additional railings, bars, trim pieces, and or coverings.

The latch mechanism 404 is configured to secure the doors 400, 402 in the closed position. The latch mechanism 404 may be engaged and/or released by an operator to close and open the doors 400, 402. The latch mechanism 404 may include a vertical bar latch (e.g., a gravity latch), a spring loaded latch, a hasp latch, a cam latch, a twist latch, a hook latch, a T-handle latch, a paddle latch, a pin latch, or other suitable latch systems. In the embodiment of FIGS. 9A-9D, the latch mechanism 404 is a vertical bar latch including a pivot rod 470 fixed to the fourth member 452 and the fifth member 456 of the second door 402 at or near the second side 450. A latch handle 472 may extend radially outward from the pivot rod 470. One or more plates 474 may circumscribe and extend radially outward from the pivot rod 470. Each of the one or more plates 474 may have a surface (not shown) defining a recess that corresponds to a shape of the third member 448 of the second door 402. As shown in FIG. 9A-9B, the one or more plates 474 includes a first plate disposed at or near the third side 454 and a second plate disposed at or near the fourth side 458. The latch handle 472 may be disposed in between the one or more plates 474, for example in the center of the pivot rod 470.

A retainer or link 476 is positioned on the body 441 of the second door 402 between the second member 444 and the third member 448. The retainer 474 may be disposed between the third member 452 and the fourth member 456 at a position that aligns with the latch handle 472. The latch handle 472 defines an aperture (not shown) extending therethrough. When the latch handle 472 is moved into a latched position, the retainer 476 is received in the aperture and retains the latch handle 474 to the second door 402. The one or more plates 474 are configured to engage the second door 402 to retain the second door 402 in the closed position. In this way, an operator can engage and disengage the latch mechanism 404 to secure and/or release the doors 400, 402 from the latched position.

As discussed above, the door assembly includes one or more hinge assemblies 410. While the description below focuses on the hinge assembly 410 mounted to the first door 400, it should be understood that the hinge assembly 410 mounted to the second door 402 is configured in the same manner. As best shown in FIGS. 9C-9D, the hinge assembly 410 includes a first hinge assembly 500, a second or upper hinge assembly 512 and a third or lower hinge assembly 514.

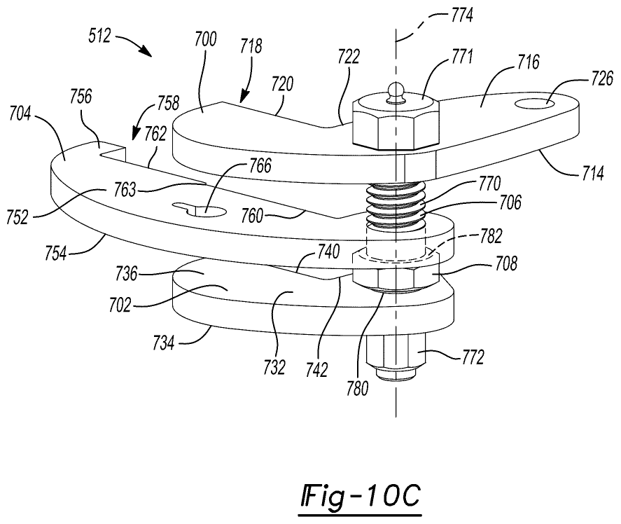

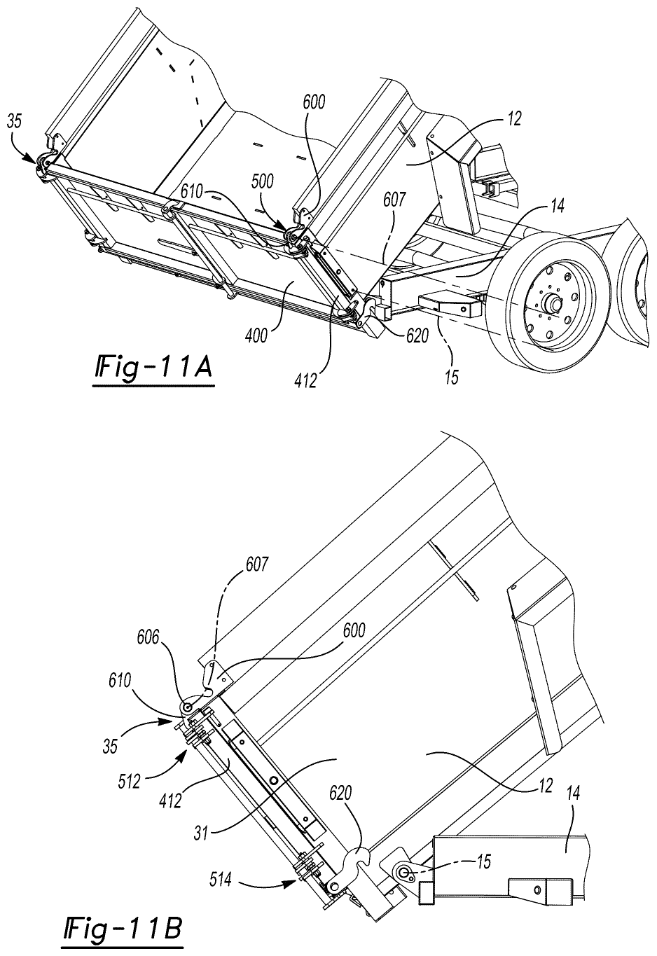

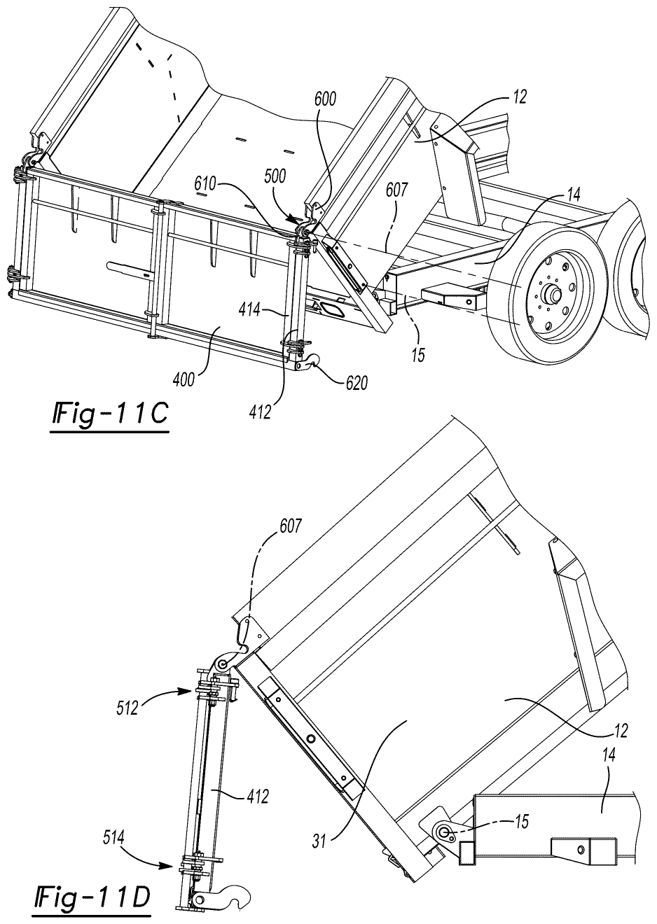

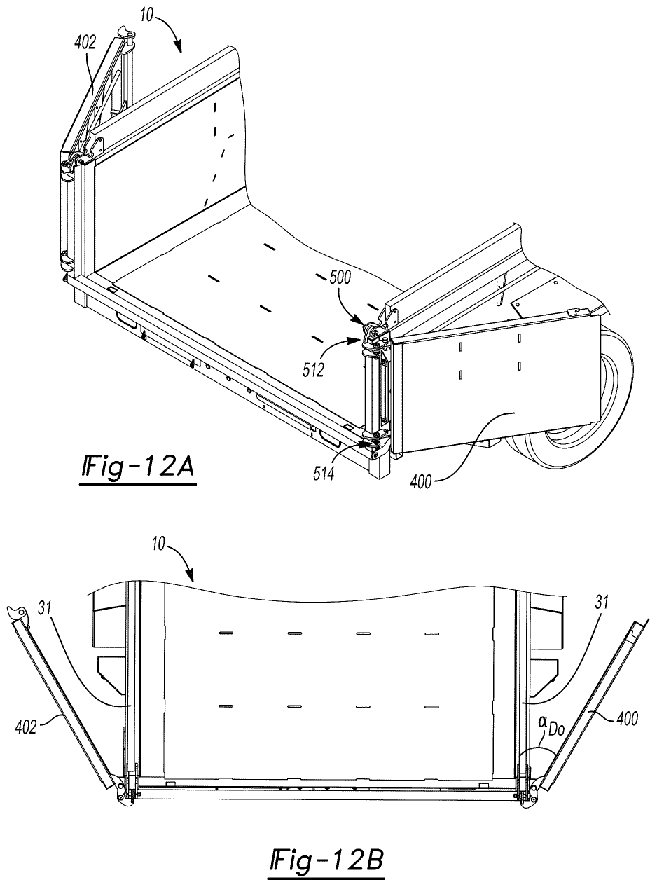

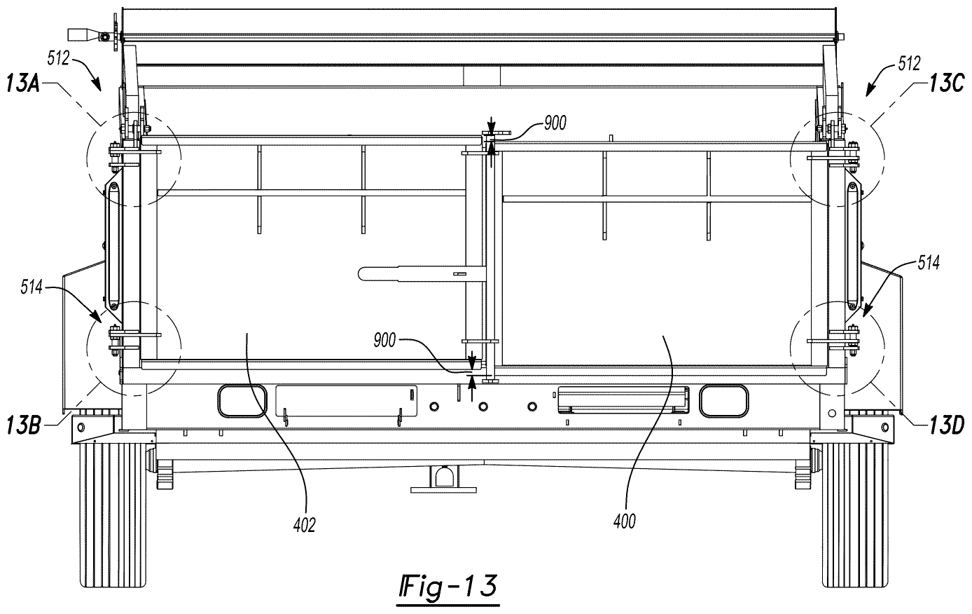

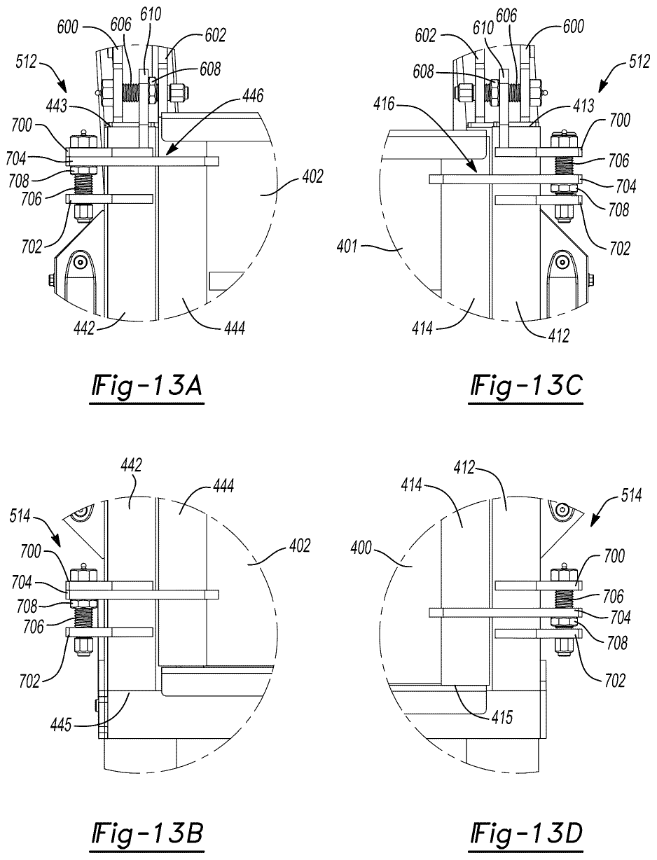

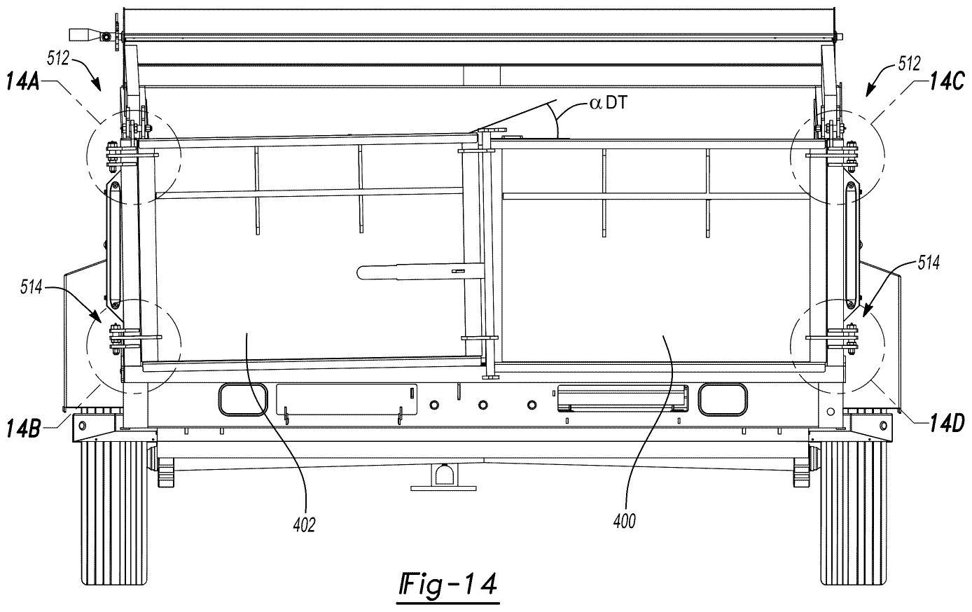

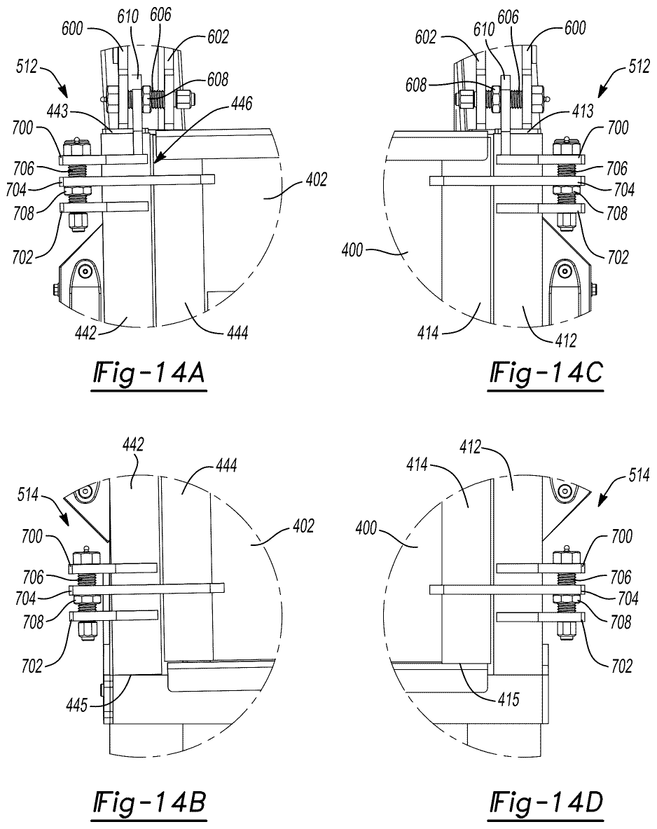

The door 400 is movable between multiple positions to facilitate the loading and removal or dumping of materials in the trailer bed 12. As will be discussed in greater detail below in the discussion accompanying FIGS. 11A-11D, the first hinge assembly 500 cooperates to move the door 400 between a first or closed position (FIGS. 11A-11B) and a pivoted or dump position (FIGS. 11C-11D). As will be discussed in greater detail below in the discussion accompanying FIGS. 12A-12B, the second hinge assembly 512 and the third hinge assembly 514 cooperate to move the door 400 from the closed position (FIGS. 9A-9B) to an open position (FIGS. 12A-12B). Additionally, as will be discussed in the discussion accompanying FIGS. 13-14, the second hinge assembly 512 and the third hinge assembly 514 cooperate to move the door 400 between vertically or axially spaced first and second positions (e.g., up and down direction C) (FIGS. 13A-13D) (see, direction C of FIGS. 1A-1D). The hinge assemblies 410 (e.g., the first hinge assembly, 500, the second hinge assembly 512, and the third hinge assembly 514) cooperate to move the door between a first position and tilted position (FIGS. 14A-14D).

The first hinge assembly 500 includes a first plate or member 600, a second plate or member 602, a third plate or member 610, a rod 606, and a retaining ring 608. The second plate 602 is spaced laterally apart from the first plate 600. Each of the first and second plates 600 and 602 may be fixed to the wall 31 of the first lateral side 28 via fasteners (not shown) (e.g., nuts, bolts, rivets, ties), brackets, welds, or links. The first plate 600 defines a first aperture 601 extending therethrough. An inner surface of the first aperture may be threaded or non-threaded. Similarly, the second plate 602 defines a second aperture 603 extending therethrough. An inner surface of the second aperture 603 may be threaded or non-threaded. A diameter 604 of the first aperture 601 of the first plate 600 may be greater than a diameter 605 of the second aperture 603 of the second plate 602. In one example, the first diameter 604 of the first aperture 601 of the first plate 600 is about 0.875 inches, and the second diameter 605 of the second aperture 603 of the second plate 602 is about 0.75 inches.

The rod 606 (e.g., a pin or a bolt) extends through the apertures 601, 603 of the first member 600 and the second member 602. The rod 606 is fixed to the first plate 600 and the second plate 602 and defines a rotation axis 607. At least a portion of a surface 613 of the rod 607 may be threaded. In some examples, the entire surface 613 of the rod 607 may be threaded. As best shown in FIGS. 9E and 9F, the rod 606 includes a first threaded portion 612 and a second threaded portion 614. The first threaded portion 612 and the second threaded portion 614 have helical ridges (i.e. “threads”) spiraling around a surface of the rod 606. The rod 606 includes a first non-threaded portion 616 and a second non-threaded portion 618 that are free of threads (i.e., have a relatively smooth surface).

The first plate 600 may circumscribe the rod 606 at the first non-threaded portion 616. For example, the inner surface of the first aperture 601 may contact the surface 613 of the rod 606 at the first non-threaded portion 616. The second plate 602 may circumscribe the rod 606 at the second non-threaded portion 618. For example, the inner surface of the second aperture 603 may contact the surface 613 of the rod 606 at the second non-threaded portion 618. The first threaded portion 612 and the first non-threaded portion 616 may define a first diameter 630. The second non-threaded portion 618 may define a second diameter 632 that is smaller than the first diameter 630. The first diameter 630 and the second diameter 632 may correspond to the first diameter 604 of the first plate 600 and the second diameter 605 of the second plate 602, respectively. The second threaded portion 616 may have a third diameter (not shown) that is less than the second diameter 632.

A first channel 620 (FIGS. 9E-9F) extends perpendicular to the rotation axis 607 (FIG. 9D) through a portion of the first non-threaded portion 616. A second channel 622 (FIGS. 9E-9F) extends perpendicular to the rotation axis 607 (FIG. 9D) through a portion of the second non-threaded portion 618. A third channel 624 (FIG. 9F) extends along the direction of the rotation axis 607 between the first channel 620 and the second channel 622. The third channel 624 may fluidly connect the first channel 620 and the second channel 624. When the rod 606 rotates, there may be friction between the rod 606 and the apertures 601, 603 of the respective first and second plates 600, 602. Grease, oil, or other fluid disposed in the first channel 620, second channel 622, and/or third channel 624 may reduce or eliminate undesirable wear and/or noise in the first hinge assembly 500. The grease, oil, or other fluid may be disposed in first channel 620, second channel 622, and/or third channel 624 and lubricate the rod 606, first plate 600 and/or second plate via the first channel 620 and/or the second channel 622.

The first hinge assembly 500 includes the third plate 610 having a first portion 614 (FIG. 9D) and a second or door engaging portion 616. The first portion 614 defines an aperture 611 (FIG. 9E) extending therethrough. An inner surface of the aperture 11 may be threaded to correspond to the threaded surface of the rod 606. The third plate 610 is positioned between the first plate 600 and the second plate 602 such that the rod 606 extends through the aperture 611. The third plate 610 may rotate about the rotation axis 607.

The door engaging portion 616 (FIG. 9D) is fixed to the first member 412 (e.g., via welding). The door engaging portion 616 may define one or more recesses 619 that are shaped to correspond to the shape of the first member 412. A first surface 621 of the one or more recesses 619 may contact and be fixed to the second end 415 of the first member 412. A second surface 622 may contact or be slightly spaced apart from the second hinge assembly 512 (e.g., the first plate 700 of the second hinge assembly 512).

The retaining ring 608 circumscribes the rod 606. The retaining ring 608 may be positioned between the second plate 602 and the third plate 610. Alternately, the retaining ring 608 may be positioned between the third plate 610 and the first plate 600. An inner surface 617 of the retaining ring 608 may be threaded to correspond to the threaded surface of the rod 606. In the embodiment shown in FIGS. 9A-9F, the retaining ring 608 is a nut.

The retaining ring 608 is movable about the axis 607 between a first position (see, e.g., FIG. 14A), a second position (see, e.g., FIG. 14B) and positions therebetween. The retaining ring 608 is configured to be tightened to the third plate 610 such that the retaining ring 608 contacts the third plate 610. When the retaining ring 608 is tightened to the third plate 610, the third plate 610 is rotatably fixed to the rod 606. In this way, when the rod 606 rotates about the axis 607, the third plate 610 also rotates about the axis 607. When the retaining ring 608 is not tightened to the third plate 610, the third plate 610 may rotate independently from the rod 606.

The rod 606 may be axially moveable relative to the first plate 600, second plate 602, and/or third plate 610. One or more nuts or retention features 609 are configured to removably secure the position of the rod 606 relative to the first plate 600, the second plate 602, and/or the third plate 610. In this way, when the nut 609 is tightened, the rod 606 is prevented from moving axially relative to first plate 600, the second plate 602, and/or the third plate. When the nut 609 is loosened, the rod 606 may be axially adjusted and move relative to the first plate 600, the second plate 602, and/or the third plate 610.

In this way, an operator may manually adjust the position of the door (see, e.g., FIG. 14) by adjusting the position of the rod 606 relative to the third plate 610. After the rod 606 is positioned relative to the first plate 600, the second plate 602, and/or the third plate 610 and axially fixed via the nut 609, the retaining ring 608 may be moved axially along the rod 606 and tightened to the third plate 610 to rotatably fix the third plate 610 to the rod 606.

As shown in FIG. 9C, the first hinge assembly 500 includes a member 628 fixed to the first member 412 of the first door 400 at or near the third side 424. The member 628 extends from a first end 629 that is rotatably fixed (e.g., welded) to the first member 412 to a second end 623 including a bed connecting portion 631. The bed connecting portion 631 defines a recess 626 that is removably coupled to a retention feature 633 of the wall 31 of the trailer bed 12. In the configuration of FIGS. 9A-9C, the bed connecting portion 631 is generally hook shaped, although other shapes and configurations are possible.

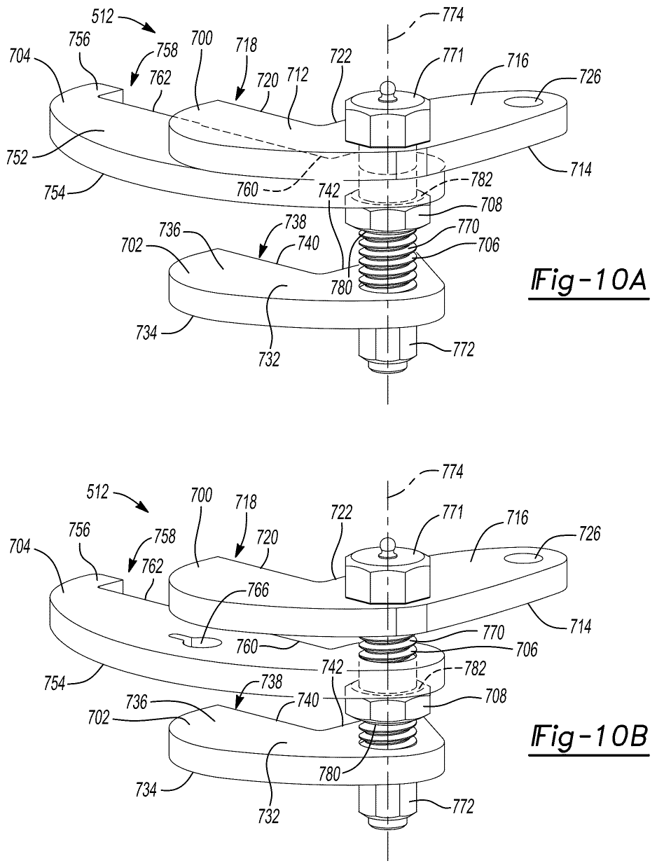

With renewed reference to FIGS. 9C-9D and 10A-10C, the second hinge assembly 512 and the third hinge assembly 514 are configured to movably mount the first member 412 to the second member 414, enable the door 400 to move between open and closed positions, and position or adjust the door 400. The second hinge assembly 512 includes a first plate 700, a second plate 702, a third plate 704, a first rod 706, a retaining ring 708, and a second rod 710.

As best shown in FIGS. 9G-9H and 10A-10C, the first plate 700 includes a body 712 (FIGS. 10A-10C) extending between a first surface 714 and a second surface 716. The first plate 700 is positioned at or near the second end 415 of the first member 412. The body 712 includes a member connecting portion 718. The member connecting portion 718 includes a first member abutting surface 720 and a second member abutting surface 722. The first and second member abutting surfaces 720, 722 are fixed to the first member 412 (e.g., via welding). Specifically, the first and second member abutting surfaces 720, 722 contact two orthogonal walls 417 of the first member 412. In this way, the shape or contour of the first and second member abutting surface 720, 722 may correspond to a shape or contour of the first member 412. The first plate 700 includes a first aperture 724 (FIG. 9G) extending therethrough. An inner surface of the first aperture 724 may be threaded or non-threaded. The first aperture 724 of the first plate 700 has a first diameter 725. The first plate 700 includes a second aperture 726 extending therethrough that is spaced apart from the first aperture.

The second plate 702 includes a body 732 (FIGS. 10A-10C) extending between a first surface 734 and a second surface 736. The second plate 702 is spaced apart from and positioned below the first plate 700. The body 732 includes a member connecting portion 738. The member connecting portion 738 includes a first member abutting surface 740 and a second member abutting surface 742. The first and second member abutting surfaces 740, 742 are fixed to the first member 412 (e.g., via welding) and contact two orthogonal walls 417 of the first member 412. The shape or contour of the first and second member abutting surface 740, 742 may correspond to a shape or contour of the first member 412. The second plate 702 includes a first aperture 744 (FIG. 9G) extending therethrough. An inner surface of the first aperture 744 may be threaded or non-threaded. The first aperture 744 of the second plate 702 has a second diameter 745. The second diameter 745 is smaller than the first diameter 725. In one example, the first diameter 725 of the first aperture 724 of the first plate 700 is about 0.875 inches, and the second diameter 745 of the first aperture 744 of the second plate 702 is about 0.75 inches.

The third plate 704 includes a body 752 extending between a first surface 754 and a second surface 756. The third plate 704 is positioned between the first plate 700 and the second plate 702. The body 752 includes a member connecting portion 758. The member connecting portion includes a first member abutting surface 760 and a second member abutting surface 762. The first member abutting surface 760 and the second member abutting surface 762 may be separated by a step 763 (FIG. 10C). In a door closed position, the first member abutting surface 760 may contact or abut the first member 412. The second member abutting surface 762 is fixed to the second member 414 (e.g., via welding) (i.e., the second member abutting surface 762 is fixed to the body 411 of the first door 400). The contour of the first member abutting surface 760 and the second member abutting surface 762 may correspond to a shape of the first member 412 and the second member 414 of the first door 400. The third plate 704 includes a first aperture 764 extending therethrough. An inner surface of the first aperture 764 may be threaded. The third plate 704 includes a second aperture 766 extending therethrough spaced apart from the first aperture.

The first rod 706 extends through the first apertures 724, 744, 764 of the first plate 700, the second plate 702 and the third plate 704, respectively. The first rod 706 is fixed to the first plate 700 and the second plate 702 and defines a rotation axis 774. The first rod 706 may have a generally cylindrical shape. At least a portion of the surface 770 of the first rod 706 may be threaded. In some examples, the entire surface 770 of the first rod 706 may be threaded. As best shown in FIG. 9G, the first rod 706 includes a first threaded portion 812, and a second threaded portion 814. The first threaded portion 812 and the second threaded portion 814 have helical ridges (i.e. “threads”) spiraling around the surface 770. The rod 706 includes a first non-threaded portion 816 a second non-threaded portion 818 that are free of threads (i.e., have a relatively smooth surface). In the embodiment of FIGS. 10A-10C, the first rod 706 is a bolt (also referred to as the “bolt 706”). The bolt 706 may be fixed to the first plate 700 via a first nut 771 and to the second plate 702 via a second nut 772. One or both of the nuts 771, 772 may be integrally formed with the rod 706.

The first plate 700 may circumscribe the rod 706 at the first non-threaded portion 816. For example, the inner surface of the first aperture 724 may contact the surface 770 (FIG. 10A-10C) of the rod 706 at the first non-threaded portion 816. The second plate 702 may circumscribe the rod 706 at the second non-threaded portion 818. For example, the inner surface of the first aperture 744 may contact the surface 770 of the rod 706 at the second non-threaded portion 818. The first threaded portion 812 and first non-threaded portion 816 may define a first diameter 830 (FIG. 9H). The second non-threaded portion 818 may define a second diameter 832 that is smaller than the first diameter 830. The first diameter 830 may correspond to the first diameter 725 of the first aperture 724 of the first plate 700. The second diameter 832 may correspond to the first diameter 745 of the first aperture 744 of the second plate 702. The second threaded portion 814 may define a third diameter (not shown) that is less than the second diameter 832.

A first channel 822 (FIGS. 9G-9H) extends perpendicular to the rotation axis 774 (FIGS. 10A-10C) through a portion of the first non-threaded portion 816. A second channel 824 (FIGS. 9G-9H) extends perpendicular to the rotation axis 774 (FIGS. 10A-10C) through a portion of the second non-threaded portion 818. A third channel 826 (FIG. 9H) extends along the direction of the rotation axis 774 between the first channel 822 and the second channel 824. The third channel 826 may fluidly connect the first channel 822 and the second channel 824. When the rod 706 rotates, there may be friction between the rod 706 and the apertures 724, 744 of the respective first and second plates 700, 702. Grease, oil, or other fluid disposed in the first channel 822, second channel 824, and/or third channel 826 may reduce or eliminate undesirable wear and/or noise in the second hinge assembly 512. The grease, oil, or other fluid may be disposed in first channel 822, second channel 824, and/or third channel 826 and lubricate the rod 706, first plate 700 and/or second plate 702 via the first channel 822 and/or the second channel 824.

The retaining ring 708 is disposed between the second plate 702 and the third plate 704. The retaining ring 708 circumscribes the first rod 706 and extends between a first surface 780 and an axially spaced second surface 782. An inner circumference of the retaining ring 708 may be threaded. In the example embodiment of FIGS. 10A-10C, the retaining ring 708 is a nut (also referred to as the “nut 708”).

The retaining ring 708 is movable along the axis 774 between a first position (FIG. 10A), a second position (FIG. 10C), and positions therebetween (see, e.g., FIG. 10B). The retaining ring 708 is configured to be tightened to the third plate 704 such that the first surface 754 of the third plate 704 contacts the second surface 782 of the retaining ring 708. When the retaining ring 708 is tightened to the third plate 704, the third plate 704 is rotatably fixed to the rod 706. In this way, when the rod 706 rotates about the axis 774, the third plate 704 (and the door 400) also rotates about the axis 774. When the retaining ring 708 is not tightened to the third plate 704, the third plate 704 may rotated independently from the rod 706.

The rod 706 may be axially moveable relative to the first plate 700, the second plate 702, and/or the third plate 704. One or more nuts or retention features 709 are configured to removably secure the position of the rode 706 relative to the first plate 700, the second plate 702, and/or the third plate 704. In this way, when the nut 709 is tightened, the rod 706 is prevented from moving axially relative to the first plate 700, the second plate 702, and/or the third plate 704. When the nut 709 is loosened, the rod 706 may be axially adjusted and move relative to the first plate 700, the second plate 702, and/or the third plate 704.

In this way, an operator may manually adjust the position of the door by adjusting the position of the rod 706 relative to the third plate 704. After the rod 706 is positioned relative to the first plate 700, the second plate 702, and/or the third plate 704, the retaining ring 708 may by moved axially along the rod 706 and tightened to the third plate 704 to rotatably fix the third plate 704 to the rod 706.

When the retaining ring 708 is moved up and/or down the first rod 706 to engage the third plate 704, the third plate becomes axially and rotatably fixed to the rod 706 (e.g., locked into position). For example, as shown in FIG. 10A, in the first position, the retaining ring 708 is fixed to the third plate 704 and spaced apart from the second plate 702 in a full-up position. The second surface 756 of the third plate 704 contacts or is slightly spaced apart from the first surface 714 of the first plate 700. As shown in in FIG. 10B, the retaining ring 708 is fixed to the third plate 704 which is spaced apart from both the first plate 700 and the second plate 702. For example, the retaining ring 708 and the third plate 704 may be positioned at about the center of the rod 706. As shown in FIG. 10C, in the second position, the retaining ring 708 is fixed to the third plate 704 and the first surface 780 of the retaining ring contacts or is slightly spaced apart from the second surface 736 of the second plate 702 in a full-down position. The third plate 704 is also positioned in the full-down position.

The second rod 710 (FIGS. 9C and 9D) is movably received in the second aperture 726 of the first plate 700 and the second aperture 766 of the third plate 704. The second rod 710 may be a pin or a bolt. As will be described in greater detail below, the second rod is configured to retain the first door 400 in an open position (see, e.g., FIG. 12A).

Referring back to FIG. 9C, the third hinge assembly 514 is the same as or similar to the second hinge assembly 512 except as otherwise described below. The third hinge assembly 514 includes a first plate 800, a second plate 802, and a third plate 804, a first rod 806, and a retaining ring 808. The second plate 802 is positioned at or near the first end 413 of the first member 412. The first plate 800 is spaced apart from and positioned above the second plate 802. While in the embodiment of FIG. 9C, the third hinge assembly 514 is free of a second rod (e.g., the second rod 710), a second rod or other retaining feature may be included in other embodiments. When the retaining ring 808 is fixed to the third plate 804, the third plate 804 and the rod 706 may rotate about the rotation axis 774 (FIG. 10A-10C).

As shown in FIGS. 11A-11D, the first door 400 is movable about the rotation axis 607 between a first or closed position (FIGS. 11A-11B), a second or pivot position (FIGS. 11C-11D), and positions therebetween. In the first position, the bed connecting portion 631 of the member 628 is engaged with the retention feature 633 of the wall 31 to retain the first door 401 to the trailer bed 12. The operator can rotate or unlatch the member 628 from the retention feature (i.e., disengage the member 628) and push the door 400 upwards and out. When the member 628 is disengaged from the wall 31, the rod 606, third plate 610, and door 400 pivot about the rotational axis 607 into the dump position (FIGS. 11C-11D). The door 400 may be returned to the closed position when the operator pushes the door inwards and down towards the trailer bed 12 and re-engages the member 628.

As shown in FIGS. 9A-9D and 12A-12B, the door assembly 35 is movable between a first or closed position (FIGS. 9A-9B), a second or open position (FIGS. 12A-12B), and positions therebetween. An operator may open one of the doors 400, 402, by disengaging the latch mechanism 404 and swinging one or both of the doors 400, 402 outwards about the rotation axis 774. Specifically, the first rod 706, the third plate 704, and the door 400 rotate about the rotation axis 774 between the closed and open positions.

In the open position (FIGS. 12A-12B), the first door 400 and the second door 402 may extend past the rear ends 26 of the first lateral side 28 of the and the second lateral side 30 of the trailer bed 12, respectively. The first door 400 and the second door 402 may extend at a door open angle α_{DO} that is greater than or equal to about 180 degrees. In other words, the first door 400 and the second door 402 may extend at the door open angle α_{DO} (FIG. 12B) that is less than or equal to 180 degrees relative to the first lateral side 28 and/or the second lateral side 30. For example, the door open angle α_{DO} may be less than or equal to about 180 degrees, less than or equal to about 160 degrees, less than or equal to about 140 degrees, less than or equal to about 120 degrees, less than or equal to about 100 degrees, less than or equal to about 80 degrees, or less than or equal to about 60 degrees. The doors 400, 402 may be spaced apart from the taillights 44, 46 such that the doors 400, 402 may extend past the taillights 44, 46 without damaging or otherwise scratching the lights 44, 46.

As best shown in FIG. 13A-13D, an axial position, or height, of each of the doors 400, 402 is adjustable. For example, each of the doors 400, 402 is movable between a first position (second door 402 of FIG. 13), a second position (first door 400 of FIG. 13), and positions therebetween. The axial position of each of the doors 400, 402 may be adjustable by moving the rod 706 relative to the third plate 704 of the second hinge assembly 512 or the rod 806 relative to the third plate 804 of the third hinge assembly 514. In the first position, the second hinge assembly 512 and the third hinge assembly 514 of the second door 402 are each in the first or full-up position (See, e.g., FIGS. 10A, 13A-B). In the second position, the second hinge assembly 512 and the third hinge assembly 514 of the first door 400 are each in the second or full-down position (See, e.g., FIGS. 10C, 13C-D). Any position of the rods 706, 806 relative to the retaining rings 708, 808 and third plates 704, 708 is possible to achieve the desired position of the door.

Each of the doors 400, 402 may be moved in a dimension of axial travel 900. In the embodiments of FIGS. 13 and 14 the dimension of axial travel 900 may be greater than or equal to about 0.1 inches to less than or equal to about 3 inches (e.g., greater than or equal to about 0.1 inches, greater than or equal to about 0.25 inches, greater than or equal to about 0.5 inches, greater than or equal to about 0.75 inches, greater than or equal to about 1.0 inches, greater than or equal to about 1.25 inches, greater than or equal to about 1.5 inches, greater than or equal to about 1.75 inches, greater than or equal to about 2.0 inches, greater than or equal to about 2.25 inches, greater than or equal to about 2.5 inches, or greater than or equal to about 2.75 inches) (e.g., less than or equal to about 3 inches, less than or equal to about 2.75 inches, less than or equal to about 2.5 inches, less than or equal to about 2.25 inches, less than or equal to about 2.0 inches, less than or equal to about 1.75 inches, less than or equal to about 1 inches, less than or equal to about 0.75 inches, less than or equal to about 0.5 inches, or less than or equal to about 0.25 inches). In one example, the dimension of axial travel 900 is about 1.5 inches. It is contemplated that the axial travel may be more than 3 inches or less than 1.5 inches and may be tailored based on the size and configuration of the door 400, 402, plates 700, 702, 704, rod 706 and retaining ring 708.

As shown in FIG. 13, when the first door 400 is in the second or full-down position and the second door 402 is in the first or full-up position, the dimension of axial travel 900 may correspond to a difference in height of a door relative to the other door or relative to one or more features of the trailer 10 (e.g., the trailer frame 14).

As best shown in FIG. 14A-14D, a tilt of each of the doors 400, 402 is adjustable. For example, the first hinge assembly 500 of each of the doors 400, 402 cooperates to move the doors 400, 402 between a first or tilted position (second door 402 of FIG. 14), a second or non-tilted position (first door 400 of FIG. 14), and positions therebetween. The tilt of each of the doors 400, 402 may be adjustable by moving the rod 606 relative to the third plate 610 of the first hinge assembly 500. In the first or tilted position, the retaining ring 608 is fixed to the third plate 610 of the first hinge assembly 500 in a first position such that a gap between the first plate 600 and the third plate 610 is smaller than a gap between the retaining ring 608 and the second plate 602. The second hinge assembly 512 of the second door 402 is in the middle position (FIGS. 10B, 14A). The third hinge assembly 514 of the second door 402 is also in the middle position (FIGS. 10B, 14B).

In the second or non-tilted position, the retaining ring 608 is fixed to the third plate 610 of the first hinge assembly 500 in a second or middle position such that a gap between the first plate 600 and the third plate 610 is about equal in dimension to a gap between the second plate 602 and the retaining ring 608. The second hinge assembly 512 and the third hinge assembly 514 of the first door 400 are both in the middle position (FIGS. 10B, 14C-D).

While not shown in FIG. 14, it is contemplated that the retaining ring 608 may be fixed to the third plate 610 in a third position such that a gap between the first plate 600 and the third plate 610 is larger than a gap between the retaining ring 608 and the second plate 602. Any position of the rod 606 relative to the retaining ring 608 and third plate 610 is possible to achieve the desired tilt of the door.

In the tilted position, the second door 402 is tilted at an angle α_{DT} relative to the first door 400 (e.g., relative to the fourth side 428 of the first door 400). The angle α_{DT} may be greater than or equal to about 5 degrees to less than or equal to about 60 degrees (e.g., greater than or equal to about 5 degrees, greater than or equal to about 10 degrees, greater than or equal to about 20 degrees, greater than or equal to about 30 degrees, greater than or equal to about 40 degrees, or greater than or equal to about 50 degrees) (e.g., less than or equal to about 60 degrees, less than or equal to about 50 degrees, less than or equal to about 40 degrees, less than or equal to about 30 degrees, less than or equal to about 20 degrees, or less than or equal to about 10 degrees).

It is contemplated that both the height (FIG. 13A-D) and the tilt (FIG. 14A-D) of one or both of the doors 400, 402 may be adjusted and tailored to achieve the desired fit, appearance, and functionality of the doors 400, 402. The ability to adjust the height and/or tilt may correct hinge sag to improve the durability and longevity of the hinge assembly 410.

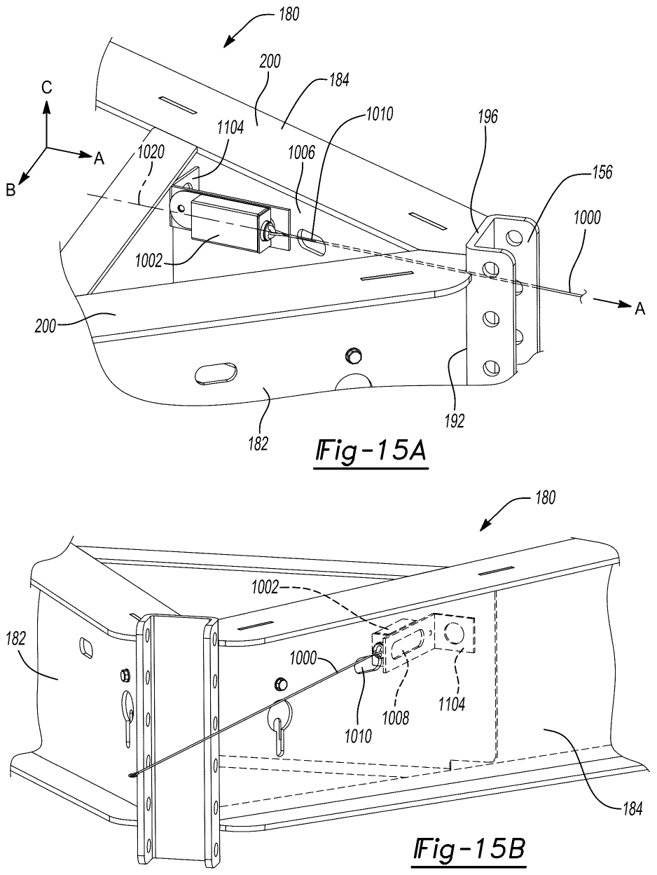

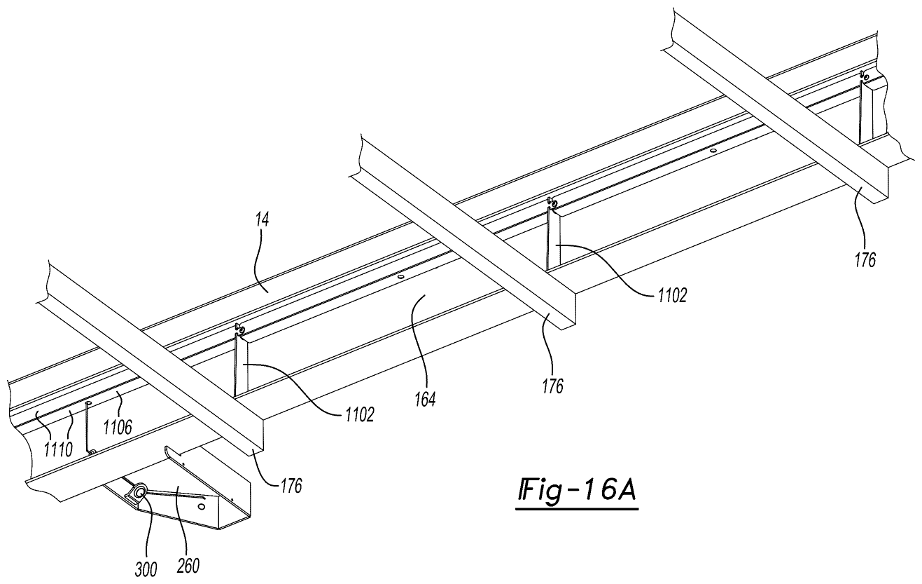

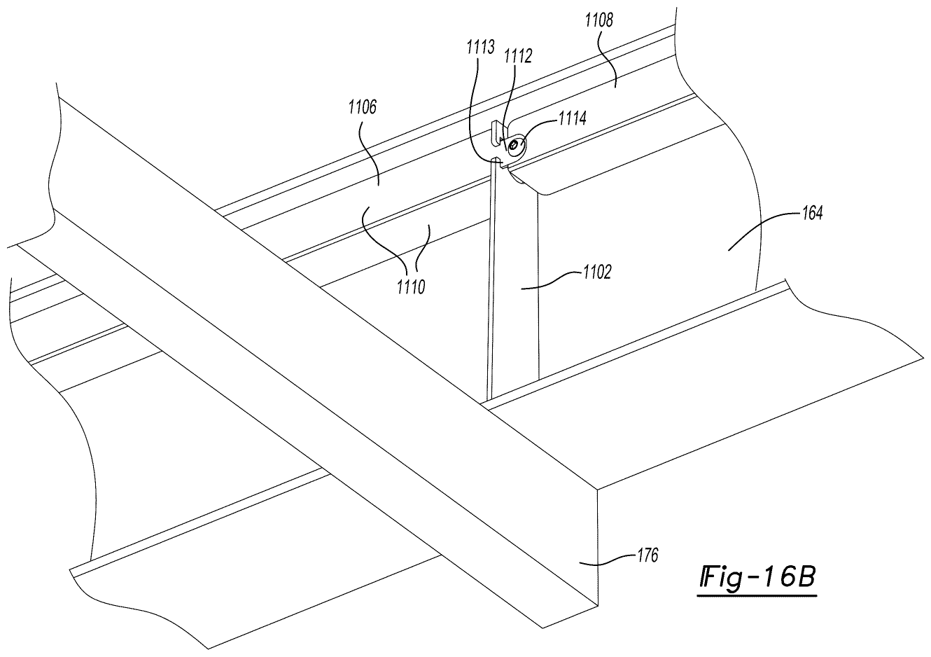

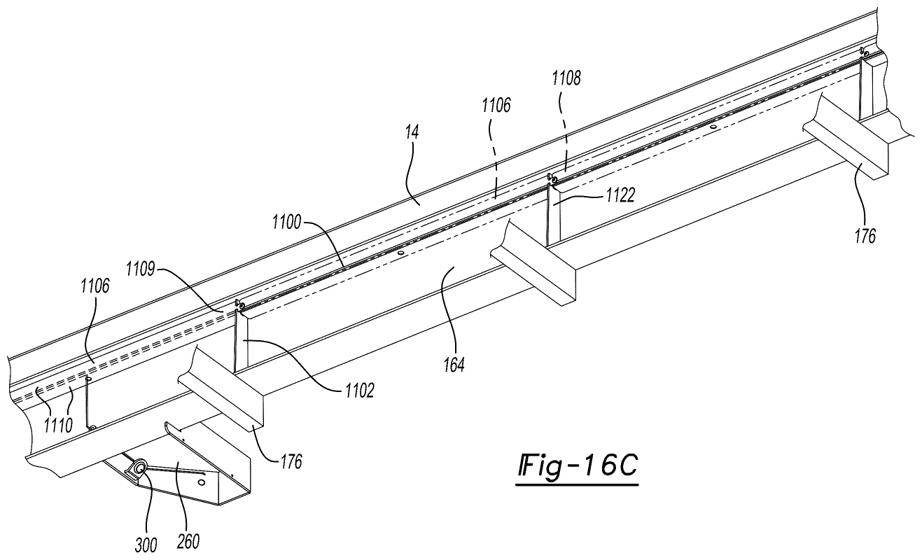

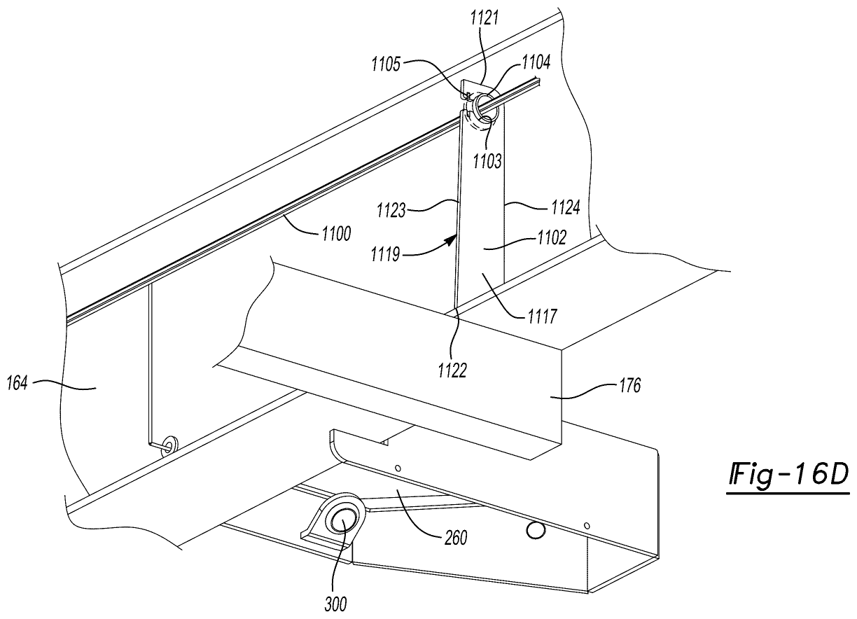

Referring now to FIGS. 15A-15B and 16A-16C, the trailer 10 may include one or more wire harnesses, cables, etc. to electrically connect various components of the trailer 10 with a power source and/or with the towing vehicle. As shown in FIGS. 15A-15B, the trailer 10 includes an emergency brake cable 1000. One end of the emergency brake cable 1000 may be connected to the towing vehicle and the other end of the emergency brake cable 1000 may be connected to a brake system (not shown) of the trailer 10. The brake system of the trailer 10 may include electric brakes, hydraulic brakes, air brakes, anti-lock brakes, and/or combinations thereof. Specifically, the emergency brake cable 1000 is connected to a breakaway switch 1002. When the emergency brake cable 1000 is pulled taught (e.g., along direction A) (e.g., when the trailer 10 detaches from the towing vehicle while in motion), the emergency brake cable 1000 will pull on the breakaway switch 1002 to activate the braking system. When the breakaway switch 1002 is activated by the emergency brake cable 1000, the brakes will engage to reduce or prevent uncontrolled rolling of the trailer 10 (e.g., reducing the speed of and/or stopping the trailer's 10 motion). The breakaway switch 1002 is mounted to the tongue assembly 180 at or near the front end 156 of the trailer frame 14. Specifically, the breakaway switch 1002 is mounted to the second tongue beam 184 at or near the second end 196. Additionally or alternatively, the breakaway switch 1002 may be mounted to the first tongue beam 182.

The breakaway switch 1002 may be mounted to the second tongue beam 184 via a bracket 1004 via one or more fasteners (e.g., nuts, bolts, rivets, ties), brackets, welds, or links. The bracket 1004 is fixed to an inner surface 1006 of the second tongue beam 184. In the embodiment of FIG. 15A-B, the bracket 1004 is generally L-shaped, although other shapes and configurations are possible. The shape of the bracket 1004 is designed to align the breakaway switch 1002 along an axis 1020 that is parallel to the towing direction (e.g., fore-aft direction or direction A). The bracket 1004 defines an aperture 1008 that is configured to receive the breakaway switch 1002 therein. In this way, the shape of the aperture 1008 may correspond to the shape of the brake module 1002.

The brake cable 1000 is routed through one or more apertures 1010 defined in the second tongue beam 184 to connect to the towing vehicle. By mounting breakaway switch 1002 to the inner surface 1006 of the tongue beam 184 and routing the brake cable 1000 through the aperture 1010, the brake cable 1000 is less likely to get damaged, disconnected, or accidentally pulled taught as compared to a system mounting a cable to an outer surface of the tongue beam 184. In this way, mounting the breakaway switch 1002 to the inner surface 1006 of the tongue beam 184 improves the reliability and durability of the emergency brake system.

With reference to FIGS. 16A-16D, the trailer 10 includes one or more wire harnesses 1100 (FIGS. 16C-16D) to electrically connect various components and systems of the trailer 10. For example, the wire harness 1100 may electrically connect the taillights 44, 46, the lights 300 disposed in the light housings 260, the brake system and/or the hydraulic cylinder assembly 22. The wire harness 1100 may include a plurality of wires or cables that are coupled together.

The wire harness 1100 of FIGS. 16A-16D may be a modular wire harness (hereafter, the “modular wire harness 1100”). The modular wire harness 1100 includes one or more sections that are electrically coupled via one or more connectors (not shown). Sections of the modular wire harness 1100 may be easily reconfigured, expanded, or repaired without disassembling the entire wire harness 1100. The modular wire harness 1100 may facilitate more efficient maintenance and customization of the trailer 10 as compared to a trailer having a conventional wire harness. The sections of the modular wire harness 1100 may pre-assembled and installed in the trailer 10.

The wire harness 1100 may be fixed to one or both of the first frame beam 164 and the second frame beam 166. The wire harness 1100 may be fixed to one or both of the frame beams 164, 166 via one or more support members 1102. The trailer 10 includes a first wire harness (e.g., the wire harness 1100) fixed to the first frame beam 164 and a second wire harness (not shown) fixed to the second frame beam 166. The first wire harness 1100 and the second wire harness may be the same except that the first wire harness 1100 connects to electronic components disposed on the first lateral side 28 and the second wire harness connects to electronic components disposed on the second lateral side 30.

The one or more support members 1102 are spaced apart and fixed to the first frame beam 164 and/or the second frame beam 166. The one or more support members 1102 may be fixed to the frame beam 164, 166 via fasteners (e.g., nuts, bolts, rivets, ties), brackets, welds, or links. Each of the one or more support members 1102 extends between a first surface 1117 and an opposite second surface 1119 (FIG. 16D). Each of the one or more support members 1102 extends between a first end 1121 and an opposite second end 1122 and between a third end 1123 and an opposite fourth end 1124. The first end 1121, second end 1122, and fourth end 1124 may abut or contact the first frame beam 164. In the embodiment of FIGS. 16A-16D, the one or more support members 1102 are generally rectangular in shape, although other shapes and configurations are contemplated.

Each of the one or more support members 1102 define a recess or aperture 1103 positioned at or near the first end 1121. The recess 1103 may configured to receive a portion of the wire harness 1100 therein. In this way, the support members 1102 are configured to retain the wire harness 1100 in position relative to the trailer frame 14.

One or more grommets 1104 may circumscribe the wire harness 1100. The one or more grommets 1104 may be pre-assembled onto the wire harness 1100. The one or more grommets 1104 may be spaced apart along a length of the wire harness 1100. The spacing of the one or more grommets 1104 disposed on the wire harness 1100 may correspond to the spacing of the support members 1102 and recesses 1103 along the trailer frame 14. For example, as shown in FIG. 16D, the shape and configuration the one or more grommets 1104 corresponds to a position of the one or more support members 1102 and the position and/or the shape of the recesses 1103 such that each of the one or more grommets 1104 are received in and engage the recess 1103 of the support member 1102. In this way, the grommets 1104 may protect the wire harness 1100 from rubbing or abrasion that may wear down insulation of the wire. Further, the one or more grommets 1104 may also seal the recess 1103 to prevent dust, dirt, and/or moisture from contaminating the wire harness 1100.

Each of the one or more support members 1102 define a slot 1105 positioned adjacent to the recess 1103 at or near the first end 1121. The slot 1105 is slightly spaced apart from the third end 1123. The recess 1103 is positioned between the slot 1105 and the fourth end 1124.

One or more wire harness covers 1106 (referred to as the “cover(s) 1106”) (FIGS. 16A-16C) may be removably secured to the first frame 164 and/or the support members 1102. Each cover 1106 extends from a first end 1108 (FIG. 16A) to a second end 1109 (FIG. 16A) opposite the first end. The cover 1106 includes a set of orthogonally intersecting walls 1110.

A protrusion or tab 1112 (FIG. 16B) extends outwardly from the second end 1109 of the cover 1106. The protrusion 1112 may have a generally semi-circular shape, although other shapes and configurations are possible. The protrusion 1112 includes a neck portion 1113 adjacent to the second end 1109. In the embodiment of FIGS. 16A-16C, a dimension (not shown) of the neck portion 1113 may be less than (e.g., narrower) than a dimension (not shown) of the semi-circular protrusion 1112. However, it is contemplated that in other embodiments, the dimensions may be the same size. The neck portion 1113 is configured to be received in the slot 1105 of the support member 1102. Accordingly, the dimension 1115 of the neck portion 1113 corresponds to a size of the slot 1105.

When in an installed position, the first end 1108 of a first cover 1106 contacts the first surface 1117 of the support member 1102. The first end 1108 of an adjacent cover 1106 contacts the first surface 1117 of an adjacent support member 1102 (i.e., a second support member 1102). The second end 1109 of the first cover 1106 contacts the second surface 1119 of the adjacent support member 1102 (i.e., the second support member 1102) such that the neck portion 1113 of the first cover 1106 is received in the slot 1105 of the adjacent support member 1102.

The protrusion 1112 of the second end 1109 may define an aperture (not shown) extending therethrough. The first end 1108 may also define an aperture (not shown) extending therethrough. The apertures of the first end 1108 and the protrusion 1112 may be aligned. The apertures are configured to receive a fastener 1114 therethrough. The second end 1109 of the first cover 1106 may be fixed to the first end 1108 of the adjacent cover 1106 via the fastener 1114. In other words, the protrusion 1112 of the second end 1109 of the first cover 1106, the first end 1108 of the adjacent cover 1106, the fastener 1114, and the support members 1102 cooperate to lock the covers 1106 into position.

A dump trailer 10 having a modular wire harness 1100 that is fixed to the frame beam 164 via the one or more support members 1102 and protected by removable covers 1106 has several benefits over conventional systems. For example, when a portion of the wire harness 1100 needs to be removed, repaired, and/or replaced, it is possible to remove the cover 1106 and swap/repair/replace the relevant portion of the module wire harness 1100, facilitating easy and efficient service of the wire harness 1100.

Additionally, the support members 1102 provide structural support to the trailer frame 14. With renewed reference to FIGS. 5A-5B, the frame 14 includes one or more laterally extending beams 176 (e.g., I-beams or C-beams) disposed below and extending between the first frame beam 164 and the second frame beam 166. The position of the support members 1102 along the trailer frame 14 corresponds to the position of the laterally extending beams 176. In other words, there is a support member 1102 fixed to the frame beam 164 above each laterally extending beam 176. The one or more beams 176 may be subject to torsional forces (i.e., twist) as the trailer 10 is towed by the vehicle. The support members 1102 are configured to stabilize and support the vertical and/or torsional movement of the beams 176 to reduce or eliminate torsion during towing.

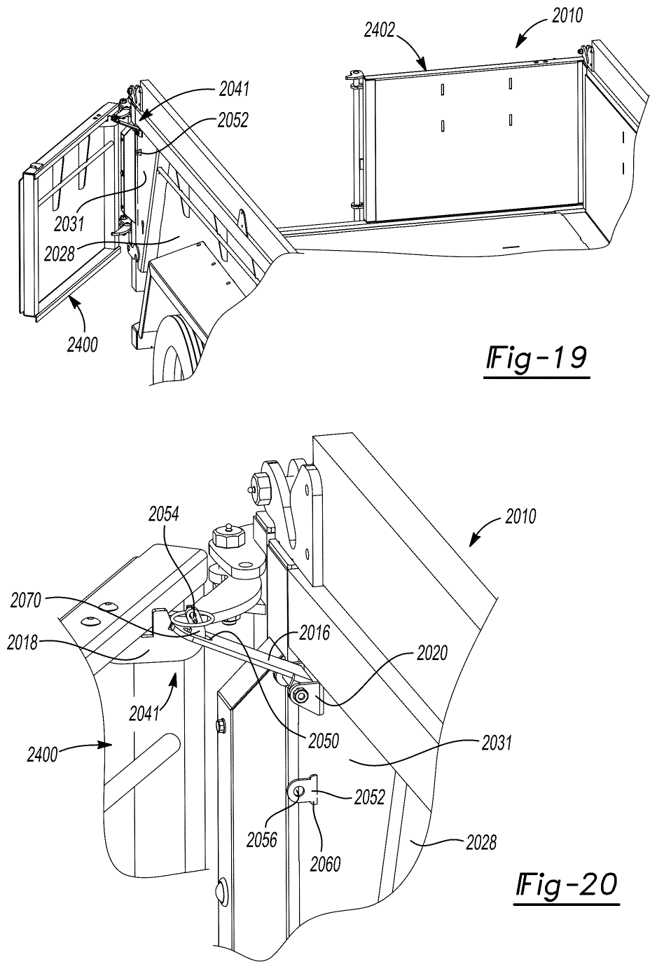

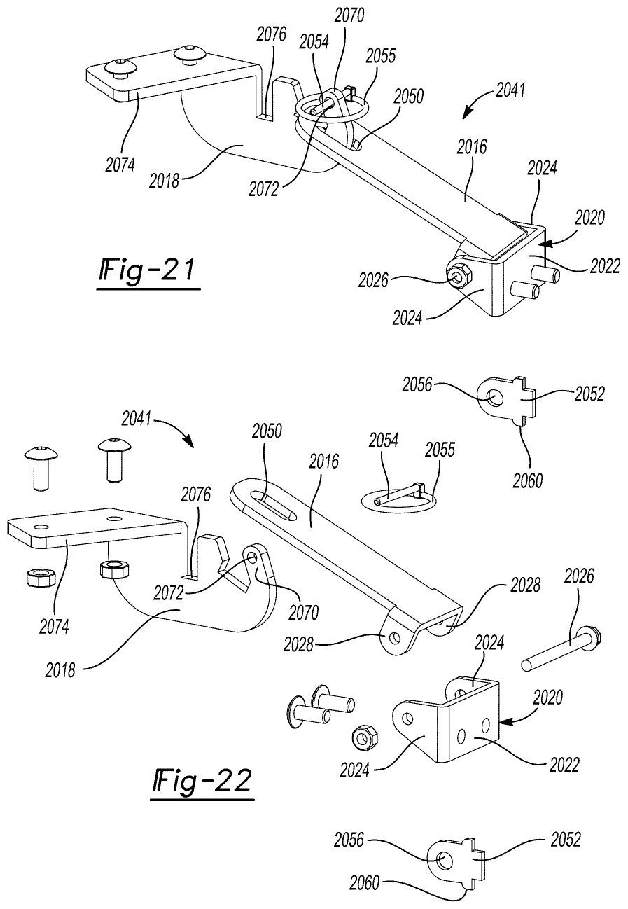

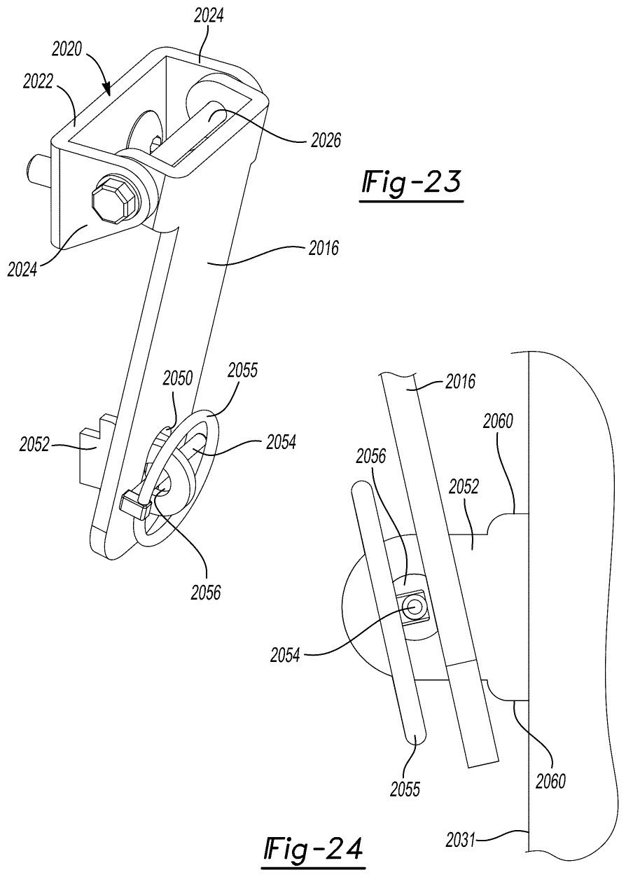

Referring now to FIGS. 17-25, another trailer 2010 is provided. The structure and function of the trailer 2010 may be similar or identical to that of the trailer 10 described above, except the trailer 2010 includes latch assemblies 2041, 2043 for retaining doors 2400, 2402 in an open position (FIG. 19 shows one of the doors 2400 retained in the open position by one of the latch assemblies 2041). The latch assemblies 2041, 2043 are movable between a latched position (FIGS. 19-21) in which the latch assembly 2041, 2043 retains the respective door 2400, 2402 in the open position and an unlatched position (FIGS. 17, 18, 23, and 24) in which the latch assembly 2041, 2043 is disengaged and allows the respective door 2400, 2402 to be moved between the open and closed positions.

The latch assembly 2041 may include a first latch member 2016 and a second latch member 2018. The first latch member 2016 may be pivotably mounted to a wall 2031 of a bed 2012 of the trailer 2010 (e.g., a lateral side 2028 of the bed 2012). The second latch member 2018 may be fixedly mounted to the door 2400. It will be appreciated that the latch assembly 2043 may be similar or identical to the latch assembly 2041 except the first latch member 2016 is mounted to wall 2033 of the opposing lateral side 2030 and the second latch member 2018 is mounted to the other door 2043.

In some configurations, the latch assembly 2041 may include a bracket 2020 that attaches the first latch member 2016 to the wall 2031. The bracket 2020 may include a base 2022 fixedly attached (e.g., welded or bolted) to the wall 2031 and a pair of tabs 2024 that extend outward from opposing ends of the base 2022. A bolt or pin 2026 may extend through apertures in the tabs 2024 and through tabs 2028 on the first latch member 2016 to pivotably attach the first latch member 20216 to the bracket 2020 and wall 2031. The pin 2026 defines a rotational axis about which the first latch member 2016 rotates. This rotational axis may be perpendicular to a rotational axis about which the door 2400, 2402 rotates relative to the wall 2031 between the open and closed positions.

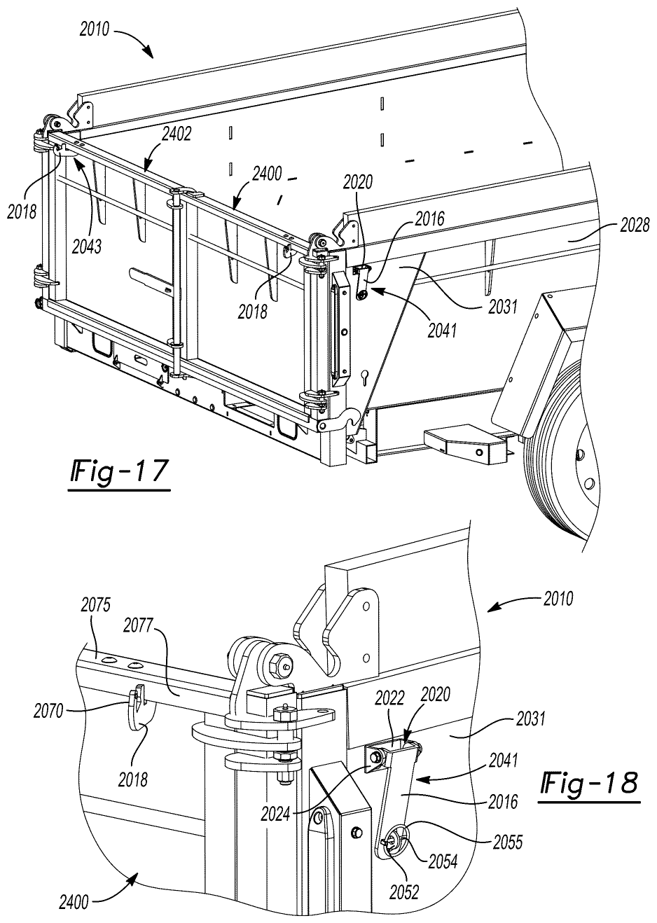

The first latch member 2016 may also include an opening (e.g., a hole or slot) 2050 that engages the second latch member 2018 when the latch assembly 2041 is in the latched position (FIGS. 19-21). In the unlatched position (FIGS. 17, 18, 23, and 24), the opening 2050 may optionally engage a stowing tab 2052 to retain the first latch member 2016 to the wall 2031 to prevent undesirable movement of the first latch member 2016 (e.g., to prevent the first latch member 2016 from flapping against the wall 2031 while the trailer is travelling down a roadway, for example). The stowing tab 2052 is fixedly attached (e.g., welded or bolted) to the wall 2031. As shown in FIGS. 18, 23, and 24, a clip or pin 2054 (e.g., linchpin, clevis pin, cotter pin, etc.) can be received in an opening (e.g., a hole or slot) 2056 in the stowing tab 2052 to retain the first latch member 2016 in engagement with the stowing tab 2052. The pin 2054 shown in the figures includes a retaining ring 2055 that is spring-biased to restrict removal of the pin 2054. The stowing tab 2052 may include one or more shoulders 2060 (i.e., portions of the stowing tab 2052 having increased width relative to the rest of the stowing tab 2052) that interfere with the first latch member 2016 to prevent the first latch member 2016 from impacting the wall 2031 and/or scratching the wall 2031.

The second latch member 2018 may be fixedly attached (e.g., bolted or welded) to the door 2400, 2402. The second latch member 2018 may include a hook 2070 having an opening 2072 (e.g., a hole or slot). The hook 2070 may be received through the opening 2050 in the first latch member 2016 to retain the first and second latch members 2016, 2018 in engagement with each other. In this manner, the first and second latch members 2016, 2018 retain the door 2400, 2402 in the open position. The pin 2054 may be subsequently inserted through the opening 2072 in the hook 2070 to prevent unintended disengagement of the first latch member 2016 from the second latch member 2018.

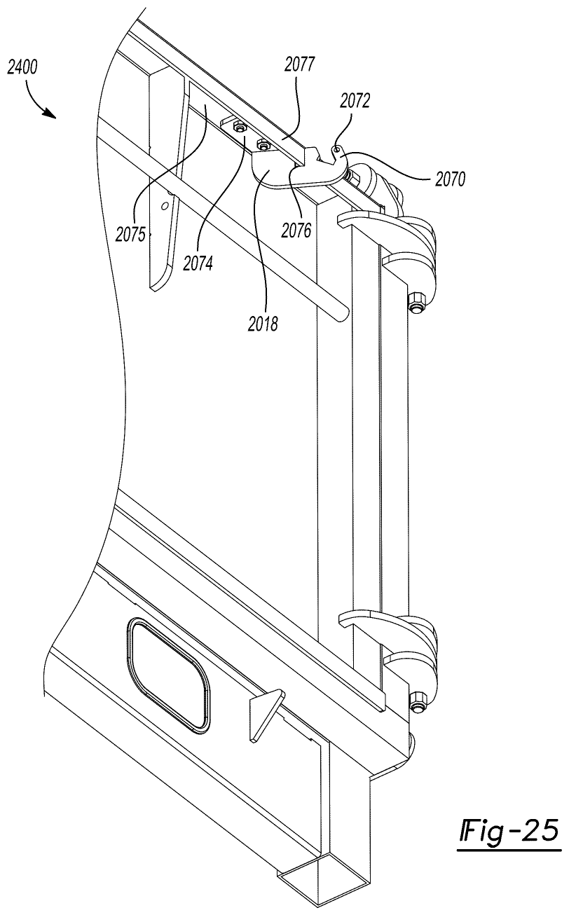

In the particular configuration shown in the figures, the second latch member 2018 includes a flange portion 2074 that is bolted to the underside of a ledge 2075 on the door 2400, 2402, as shown in FIG. 25. The second latch member 2018 may also include a slot 2076 that receives a lip 2077 of the ledge 2075 of the door 2400, 2402.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A hinge assembly for a trailer, comprising:
a rod defining a rotation axis;
a first plate fixed relative to the rotation axis, the first plate defining a first aperture extending therethrough;
a second plate fixed relative to the rotation axis, the second plate defining a second aperture extending therethrough;
a third plate disposed between the first plate and the second plate and rotatable about the rotation axis, the third plate defining a third aperture extending therethrough, wherein the third plate is fixed to a door of the trailer; and
a retaining ring circumscribing and engaging the rod, the retaining ring being disposed between the third plate and one of the first plate or the second plate,
wherein:
the rod extends through the first aperture, the second aperture, and the third aperture,
the retaining ring is axially movable along the rod between the first plate and the second plate, and
the retaining ring is configured to tighten to the third plate to rotatably fix the third plate and the rod.

2. The hinge assembly of claim 1, wherein the rod comprises a first threaded portion, a second threaded portion, a first non-threaded portion, and a second non-threaded portion.

3. The hinge assembly of claim 2, wherein a diameter of the first threaded portion and the first non-threaded portion is greater than a diameter of the second non-threaded portion.

4. The hinge assembly of claim 2, wherein the first aperture of the first plate circumscribes the rod at the first non-threaded portion, and wherein the second aperture of the second plate circumscribes the rod at the second non-threaded portion.

5. (canceled)

6. The hinge assembly of claim 2, wherein the rod further comprises:
a first channel extending through a portion of the first non-threaded portion in a direction perpendicular to the rotation axis,
a second channel extending through a portion of the second non-threaded portion in the direction perpendicular to the rotation axis, and
a third channel extending between the first channel and the second channel in a direction parallel to the rotation axis, wherein the third channel fluidly connects the first channel and the second channel,
wherein fluid disposed in at least one of the first channel, second channel, and third channel is configured to lubricate the hinge assembly.

7. (canceled)

8. The hinge assembly of claim 1, wherein a diameter of the first aperture of the first plate is greater than a diameter of the second aperture of the second plate.

9. The hinge assembly of claim 1, wherein a height of the door is adjusted in response to moving the rod relative to the third plate between a first position and a second position.

10. The hinge assembly of claim 1, wherein a tilt of the door is adjusted in response to moving the rod relative to the third plate between a first position and a second position.

11. A hinge assembly comprising:
a rod defining a rotation axis;
a first plate fixed relative to the rotation axis, the first plate defining a first aperture extending therethrough;
a second plate fixed relative to the rotation axis, the second plate defining a second aperture extending therethrough;
a third plate disposed between the first plate and the second plate and rotatable about the rotation axis, the third plate defining a third aperture extending therethrough, wherein third plate is fixed to a movable door; and
a retaining ring circumscribing and engaging the rod, the retaining ring being disposed between the third plate and one of the first plate or the second plate,
wherein:
the rod extends through the first aperture, the second aperture, and the third aperture,
the retaining ring is axially movable along the rod between the first plate and the second plate, and
the retaining ring is configured to tighten to the third plate to rotatably fix the third plate and the rod.

12. The hinge assembly of claim 11, wherein the rod comprises a first threaded portion, a second threaded portion, a first non-threaded portion, and a second non-threaded portion, and wherein a diameter of the first threaded portion and the first non-threaded portion is greater than a diameter of the second non-threaded portion.

13. (canceled)

14. The hinge assembly of claim 12, wherein the first aperture of the first plate circumscribes the rod at the first non-threaded portion, and wherein the second aperture of the second plate circumscribes the rod at the second non-threaded portion.

15. (canceled)

16. The hinge assembly of claim 12, wherein the rod further comprises:
a first channel extending through a portion of the first non-threaded portion in a direction perpendicular to the rotation axis,
a second channel extending through a portion of the second non-threaded portion in a direction perpendicular to the rotation axis, and
a third channel extending between the first channel and the second channel in the direction parallel to the rotation axis, wherein the third channel fluidly connects the first channel and the second channel.

17. (canceled)

18. The hinge assembly of claim 11, wherein a diameter of the first aperture of the first plate is greater than a diameter of the second aperture of the second plate.

19. The hinge assembly of claim 11, wherein a height of the door is adjusted in response to moving the rod relative to the third plate between a first position and a second position, and wherein a tilt of the door is adjusted in response to moving the rod relative to the third plate between a first position and a second position.

20. (canceled)

21. A door assembly for a trailer comprising:
a door configured to move between a closed position and an open position, and
a first hinge assembly comprising:
a first rod defining a first rotation axis;
a first plate fixed relative to the first rotation axis, the first plate defining a first aperture extending therethrough;
a second plate fixed relative to the first rotation axis, the second plate defining a second aperture extending therethrough;
a third plate disposed between the first plate and the second plate and rotatable about the first rotation axis, the third plate defining a third aperture extending therethrough, wherein the third plate is fixed to the door; and
a first retaining ring circumscribing and engaging the first rod, the first retaining ring being disposed between the third plate and one of the first plate or the second plate,
wherein:
the first rod extends through the first aperture, the second aperture, and the third aperture,
the first retaining ring is axially movable along the first rod between the first plate and the second plate, and
the first retaining ring is configured to tighten to the third plate to rotatably fix the third plate and the first rod.

22. The door assembly of claim 21, wherein the first rod comprises a first threaded portion, a second threaded portion, a first non-threaded portion, and a second non-threaded portion.

23. The door assembly of claim 22, wherein a diameter of the first threaded portion and the first non-threaded portion is greater than a diameter of the second non-threaded portion, wherein the first aperture of the first plate circumscribes the first rod at the first non-threaded portion, and wherein the second aperture of the second plate circumscribes the first rod at the second non-threaded portion.

24-25. (canceled)

26. The door assembly of claim 22, wherein the first rod further comprises:
a first channel extending through a portion of the first non-threaded portion in a direction perpendicular to the first rotation axis,
a second channel extending through a portion of the second non-threaded portion in a direction perpendicular to the first rotation axis, and
a third channel extending between the first channel and the second channel in the direction parallel to the first rotation axis, wherein the third channel fluidly connects the first channel and the second channel.

27. (canceled)

28. The door assembly of claim 21, further comprising a second hinge assembly comprising:
a second rod defining a second rotation axis, wherein the second rotation axis is perpendicular to the first rotation axis;
a fourth plate fixed relative to the second rotation axis, the fourth plate defining a fourth aperture extending therethrough;
a fifth plate fixed relative to the second rotation axis, the fifth plate defining a fifth aperture extending therethrough;
a sixth plate disposed between the fourth plate and the fifth plate and rotatable about the second rotation axis, the sixth plate defining a sixth aperture extending therethrough, wherein the sixth plate is fixed to the door; and
a second retaining ring circumscribing and engaging the second rod, the second retaining ring being disposed between the sixth plate and one of the fourth plate or the fifth plate,
wherein:
the second rod extends through the fourth aperture, the fifth aperture, and the sixth aperture,
the second retaining ring is axially movable along the second rod between the fourth plate and the fifth plate, and
the second retaining ring is configured to tighten to the sixth plate to rotatably fix the sixth plate and the second rod.

29. The door assembly of claim 21, wherein a height of the door is adjusted in response to moving the first rod relative to the third plate between a first position and a second position, and wherein a tilt of the door is adjusted in response to moving the first rod relative to the third plate between a first position and a second position.

30-133. (canceled)
